(19) United States
(12) Patent Application Publication
(10) Pub. No.: US 2019/0112970 A1
(43) Pub. Date: Apr. 18, 2019

(54) EXHAUST SYSTEM APPARATUS FOR INTERNAL COMBUSTION ENGINE

(71) Applicant: TOYOTA JIDOSHA KABUSHIKI KAISHA, Toyota-shi (JP)

(72) Inventor: Keiichi GOTO, Aichi-ken (JP)

(73) Assignee: TOYOTA JIDOSHA KABUSHIKI KAISHA, Toyota-shi (JP)

(21) Appl. No.: 16/145,730

(22) Filed: Sep. 28, 2018

(30) Foreign Application Priority Data
Oct. 17, 2017 (JP) 2017-201137

(51) Int. Cl. F02B 37/02; F01N 13/14; F02C 7/24; F02B 39/00; F02C 6/06

(52) U.S. Cl. CPC F02B 37/02; F01N 13/14; F02C 7/24; F05B 2260/231; F02C 6/06; F05B 2220/40; F02B 39/005

(57) ABSTRACT

An exhaust system apparatus for an engine includes an exhaust conduit member, which is connected to the rear face of the engine body, and a heat shield member, which covers the exhaust conduit member. The heat shield member has a curved-side body portion, which covers a curved portion of the exhaust conduit member, an inner flange portion, which extends from the curved-side body portion and is arranged in the region on the inner peripheral side of the curved portion, and an outer flange portion, which extends from the curved-side body portion and is arranged in the region on the outer peripheral side of the curved portion. The extending length of the inner flange portion in a direction away from the curved-side body portion is longer than the extending length of the outer flange portion in a direction away from the curved-side body portion.

### BACKGROUND

The present disclosure relates to an exhaust system apparatus for an internal combustion engine.

The exhaust system apparatus described in Japanese Laid-Open Patent Publication No. 2004-124767 has an exhaust conduit, which is connected to the engine body of an internal combustion engine and allows exhaust gas flows to flow therethrough. The exhaust conduit is curved into a U-shaped. The exhaust conduit has one end connected to the front face of the engine body and extends from that end to the rear of the vehicle by passing the side of the engine body. The exhaust system apparatus described in the above publication has a heat shield plate, which covers the curved portion of the exhaust conduit. The heat shield plate includes an upper plate portion and a lower plate portion. The upper plate portion includes an upper body portion having a semicircular cross-sectional shape and a pair of upper flanges extending radially outward from the opposite ends in the circumferential direction of the upper body portion. The lower plate portion includes a lower body portion having a semicircular cross-sectional shape and a pair of lower flanges extending radially outward from the opposite ends in the circumferential direction of the lower body portion. With the upper flange and the lower flange abutting against each other, the outer circumferential surfaces of the upper plate portion and the lower plate portion are clamped with an annular band, so that a heat shield plate having a circular cross-sectional shape is provided.

### SUMMARY

In the exhaust system apparatus described in the above publication, the exhaust conduit is connected to the front face of the engine body, which is located on the front side in the front-rear direction of the vehicle. In contrast, if the exhaust conduit is connected to the rear face of the engine body, which is located on the rear side in the front-rear direction of the vehicle, it is necessary to take countermeasures against the heat different from those of the exhaust system apparatus described in the above-mentioned publication.

In accordance with one aspect of the present disclosure, an exhaust system apparatus for an internal combustion engine mounted on a vehicle is provided. The internal combustion engine includes an engine body having a rear face located on a rear side in a front-rear direction of the vehicle. The exhaust system apparatus includes an exhaust conduit member, which is configured to be connected to the rear face of the engine body and allow exhaust gas to flow inside, a heat shield member, which covers the exhaust conduit member. The exhaust conduit member includes a curved portion. A region on an inner peripheral side of the curved portion is an inner peripheral region. A region on an outer peripheral side of the curved portion is an outer peripheral region. The heat shield member has a curved-side body portion, which covers the curved portion, an inner flange portion, which extends from the curved-side body portion and is arranged in the inner peripheral region, and an outer flange portion, which extends from the curved-side body portion and is arranged in the outer peripheral region. An extending length of the inner flange portion in a direction away from the curved-side body portion is longer than an extending length of the outer flange portion in a direction away from the curved-side body portion.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a perspective view schematically showing an exhaust system apparatus for an internal combustion engine arranged in the engine compartment of a vehicle;

FIG. 2 is a rear view of the exhaust system apparatus for an internal combustion engine of FIG. 1;

FIG. 3 is a perspective view showing the structure of the exhaust conduit in the exhaust system apparatus of FIG. 1;

FIG. 4 is a right side view of the exhaust system apparatus for an internal combustion engine of FIG. 1;

FIG. 5 is a cross-sectional view showing the arrangement of components in the engine compartment;

FIG. 6 is an enlarged cross-sectional view of the exhaust system apparatus of FIG. 4; and

FIG. 7 is an enlarged rear view showing the inner peripheral region of the curved portion of the exhaust conduit in the exhaust system apparatus of FIG. 1.

### DETAILED DESCRIPTION

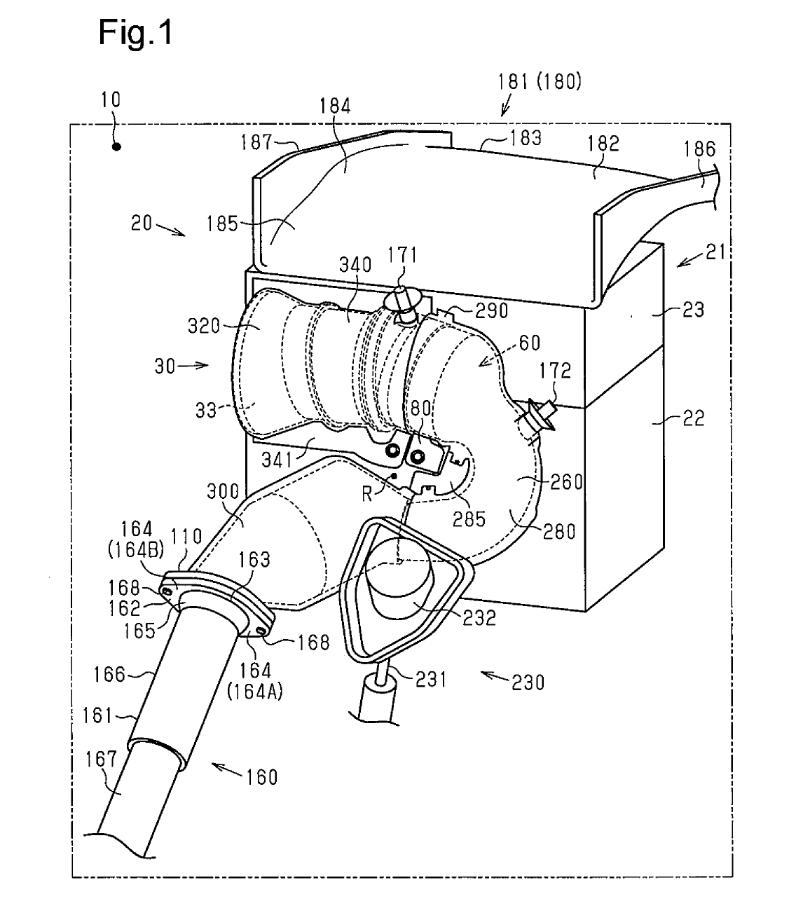

An exhaust system apparatus for an internal combustion engine according to one embodiment will now be described with reference to FIGS. 1 to 7. In the following description, the upward, downward, forward, rearward, leftward, and rightward orientations are defined with reference to the vehicle, and the orientations of components including the internal combustion engine refer to orientations in a state in which the internal combustion engine is mounted on the vehicle.

As shown in FIG. 1, an internal combustion engine 20 is mounted in an engine compartment 10 of a vehicle. The engine 20 has an engine body 21. The engine body 21 includes a cylinder block 22 and a cylinder head 23 coupled to the upper end of the cylinder block 22. A forced-induction device 30 is arranged rearward of the engine body 21.

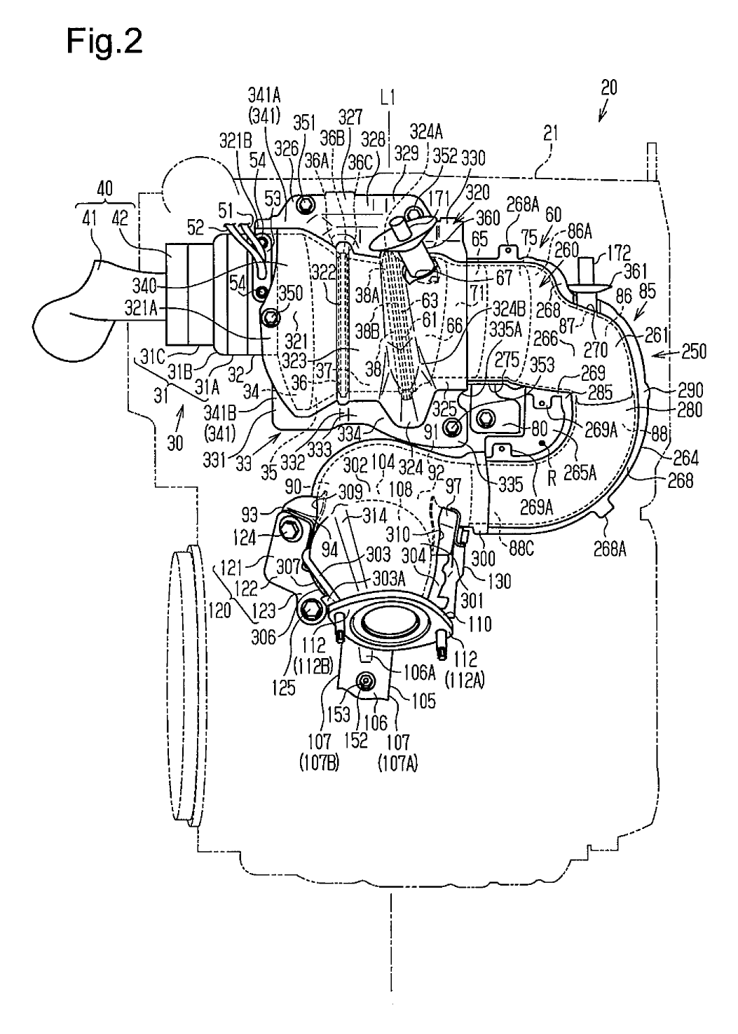

As shown in FIG. 2, the forced-induction device 30 includes a compressor housing 31, which is a component of the intake passage of the engine 20, a turbine housing 33, which is a component of the exhaust passage of the engine 20, and a bearing housing 32, which couples the compressor housing 31 and the turbine housing 33 to each other.

The compressor housing 31 is located at the left end (the left end as viewed in FIG. 2) of the engine body 21 in the vehicle width direction (left-right direction in FIG. 2). That is, the compressor housing 31 is located to the left of a first center line L1, which extends in the vehicle up-down direction (the up-down direction in FIG. 2) through the center in the vehicle width direction of the cylinder head 23. The compressor housing 31 includes a compressor accommodating portion 31A, an air intake portion 31B, which is provided on the upstream side in the intake flow (the left side as viewed in FIG. 2) of the compressor accommodating portion 31A, and an intake conduit connecting portion 31C, which is provided on the upstream side of the air intake portion 31B. The compressor accommodating portion 31A extends in the vehicle width direction and has a columnar outer shape. The compressor accommodating portion 31A has inside an accommodation space, which accommodates a compressor (not shown). The air intake portion 31B has a cylindrical shape that extends in the vehicle width direction. The right end of the air intake portion 31B, which is adjacent to the compressor accommodating portion 31A, has the same shape as the left end of the compressor accommodating portion 31A, which is adjacent to the air intake portion 31B. The air intake portion 31B has a diameter that decreases from the right end, which is adjacent to the compressor accommodating portion 31A, toward the left end, which is adjacent to the intake conduit connecting portion 31C. The outer shape of the air intake portion 31B is curved such that the degree of decrease in diameter increases toward the left end. The intake conduit connecting portion 31C has a tubular shape that extends in the vehicle width direction, and the outer diameter thereof is equal to the outer diameter at the left end of the air intake portion 31B. The outer diameter of the intake conduit connecting portion 31C is smaller than the outer diameter of the compressor accommodating portion 31A.

An intake conduit 40, which is a component of the intake passage, is connected to the compressor housing 31. The intake conduit 40 has a tubular intake main conduit 41, through which intake air flows, and a connecting flange portion 42, which is provided at the end of the intake main conduit 41 on the downstream side in the intake flow (the right end as viewed in FIG. 2). The intake main conduit 41 extends leftward beyond the left end of the engine body 21. The intake main conduit 41 extends toward the front of the vehicle from the compressor housing 31, passing by the left side of the engine body 21. The connecting flange portion 42 has a larger outer diameter than that of the intake main conduit 41. The outer diameter of the connecting flange portion 42 is equal to the outer diameter of the intake conduit connecting portion 31C of the compressor housing 31. The connecting flange portion 42 is connected to the intake conduit connecting portion 31C, so that the intake conduit 40 communicates with the compressor housing 31. This conducts the intake air flowing through the intake conduit 40 to the compressor housing 31.

The bearing housing 32 has a columnar outer shape that extends in the vehicle width direction. The bearing housing 32 has inside an accommodation space, which accommodates a bearing (not shown). The bearing rotationally supports a rotary shaft having a first end connected to the compressor. A lubricant supply tube 51 for supplying lubricant to the bearing is connected to the bearing housing 32. A coolant supply tube 52 for supplying coolant to the bearing housing 32 is connected to the bearing housing 32. The end of the lubricant supply tube 51 connected to the bearing housing 32 and the end of the coolant supply tube 52 connected to the bearing housing 32 are fitted in a single support plate 53. The support plate 53 is an elliptical plate extending in the up-down direction of the vehicle and is arranged along the outer circumferential surface of the bearing housing 32. The support plate 53 is fastened to the bearing housing 32 with fastening bolts 54, which are inserted through the opposite ends in the up-down direction of the support plate 53. This fixes the lubricant supply tube 51 and the coolant supply tube 52 to the bearing housing 32 so as not to be detached therefrom.

The turbine housing 33 is located to the right of the bearing housing 32 and has a right end portion, which is arranged across the first center line L1. The turbine housing 33 has a turbine accommodating portion 34, which is connected to the bearing housing 32, an exhaust discharge portion 35, which is provided on the downstream side in exhaust gas flow (the right side as viewed in FIG. 2) of the turbine accommodating portion 34, and a turbine large-diameter portion 36, which is provided on the downstream side in exhaust gas flow of the exhaust discharge portion 35. The turbine housing 33 further includes an exhaust flow portion 37, which is provided on the downstream side of the turbine large-diameter portion 36, and an exhaust conduit connecting portion 38, which is provided on the downstream side of the exhaust flow portion 37.

The turbine accommodating portion 34 is connected to the rear face of the engine body 21. The rear face of the engine body 21 is the surface of the engine body 21 that is located on the rear side (or facing rearward) in the vehicle front-rear direction. Exhaust gas discharged from the engine body 21 flows into the turbine accommodating portion 34. The turbine accommodating portion 34 is longer in the vehicle up-down direction than the bearing housing 32. In the vehicle up-down direction, the upper end of the turbine accommodating portion 34 is arranged at the same position as the upper end of the bearing housing 32, and the lower end of the turbine accommodating portion 34 is arranged below the lower end of the bearing housing 32. The turbine accommodating portion 34 has an accommodation space, which accommodates a turbine (not shown). A second end of the above-mentioned rotary shaft is connected to the turbine. The exhaust gas drawn in from the engine body 21 rotates the turbine. Since the turbine and the compressor are connected to each other by the rotary shaft, the compressor rotates as the turbine rotates.

The exhaust discharge portion 35 has a cylindrical shape that extends in the vehicle width direction. The left end of the exhaust discharge portion 35, which is adjacent to the turbine accommodating portion 34, has the same shape as the right end of the turbine accommodating portion 34, which is adjacent to the exhaust discharge portion 35. The exhaust discharge portion 35 has a diameter that decreases as the distance from the turbine accommodating portion 34 increases. The turbine large-diameter portion 36 includes a left flare portion 36A, which is adjacent to the exhaust discharge portion 35, a central large-diameter portion 36B, which is provided on the downstream side of the left flare portion 36A, and a right flare portion 36C, which is provided on the downstream side of the central large-diameter portion 36B. The outer diameter of the central large-diameter portion 36B is larger than the outer diameter at the right end of the exhaust discharge portion 35. Also, the outer diameter of the central large-diameter portion 36B is smaller than the outer diameter at the left end of the exhaust discharge portion 35. The left flare portion 36A has a diameter that increases toward the downstream side. The outer diameter of the left end of the left flare portion 36A is equal to the outer diameter at the right end of the exhaust discharge portion 35, and the outer diameter at the right end of the left flare portion 36A is equal to the outer diameter of the central large-diameter portion 36B. The right flare portion 36C has a diameter that decreases toward the downstream side. The outer diameter of the left end of the right flare portion 36C is equal to the outer diameter of the central large-diameter portion 36B, and the outer diameter at the right end of the right flare portion 36C is equal to the outer diameter at the right end of the exhaust discharge portion 35, that is, the outer diameter at the left end of the left flare portion 36A.

The exhaust flow portion 37 has a cylindrical shape that extends in the vehicle width direction. The exhaust flow portion 37 has a funnel-like outer shape, the diameter of which decreases toward the downstream side. The upper end of the exhaust flow portion 37 is inclined so as to descend toward the downstream side.

The exhaust conduit connecting portion 38 is inclined with respect to the vehicle up-down direction so as to be progressively shifted to the left toward the upper end. The exhaust conduit connecting portion 38 includes a first flare portion 38A, which is arranged on the upstream side in exhaust gas flow, and a connecting annular portion 38B, which is provided on the downstream side in exhaust gas flow of the first flare portion 38A. The outer diameter of the connecting annular portion 38B is larger than the outer diameter of the central large-diameter portion 36B of the turbine large-diameter portion 36. The upper end of the connecting annular portion 38B is located above the upper end of the central large-diameter portion 36B, and the lower end of the connecting annular portion 38B is located below the lower end of the central large-diameter portion 36B. The first flare portion 38A has a diameter that increases toward the right end, which is adjacent to the connecting annular portion 38B. The outer diameter at the left end of the first flare portion 38A is equal to the outer diameter at the right end of the exhaust flow portion 37, and the outer diameter at the right end of the first flare portion 38A is equal to the outer diameter of the connecting annular portion 38B. An exhaust conduit 60 is connected to the end on the downstream side of the turbine housing 33.

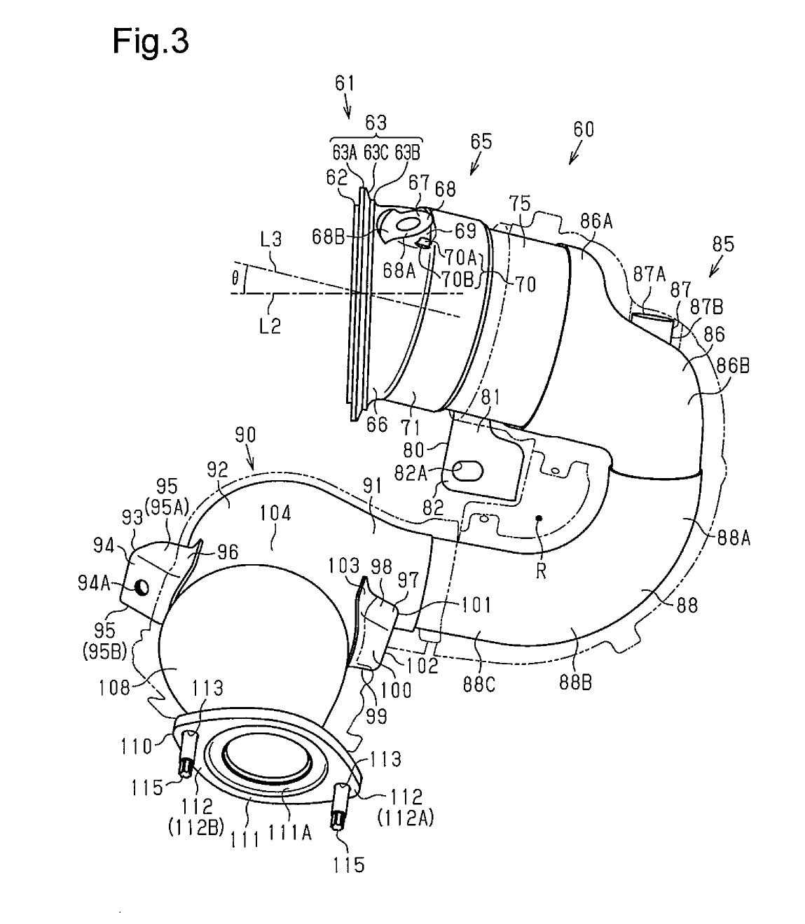

As shown in FIG. 3, the exhaust conduit 60 includes a turbine connecting portion 61, which is connected to the exhaust conduit connecting portion 38 of the turbine housing 33, a sensor mount 65, which is provided on the downstream side of the turbine connecting portion 61, a first catalyst support portion 75, which is provided on the downstream side of the sensor mount 65, and a bracket 80, which is fixed to the first catalyst support portion 75. The exhaust conduit 60 also includes a curved shape portion 85, which is provided on the downstream side of the first catalyst support portion 75, a second catalyst support portion 90, which is provided on the downstream side of the curved shape portion 85, and an exhaust pipe connecting portion 110, which is provided on the downstream side of the second catalyst support portion 90. In the exhaust conduit 60, the turbine connecting portion 61, the sensor mount 65, the first catalyst support portion 75, the curved shape portion 85, the second catalyst support portion 90, and the exhaust pipe connecting portion 110 constitute an exhaust main conduit.

The turbine connecting portion 61 includes a tubular insertion portion 62 and a second flare portion 63. The second flare portion 63 includes an upstream annular portion 63A, which constitutes the end on the upstream side (the left side as viewed in FIG. 3), a downstream annular portion 63B, which constitutes the end on the downstream side (the right side as viewed in FIG. 3), and a flare conduit portion 63C, which connects the upstream annular portion 63A and the downstream annular portion 63B to each other. The outer diameter of the upstream annular portion 63A is larger than the outer diameter of the downstream annular portion 63B. The flare conduit portion 63C has a cylindrical shape the outer diameter of which decreases toward the downstream annular portion 63B. The outer diameter of the end adjacent to the upstream annular portion 63A is equal to the outer diameter of the upstream annular portion 63A. The outer diameter of the end adjacent to the downstream annular portion 63B is equal to the outer diameter of the downstream annular portion 63B. The insertion portion 62 extends leftward from the periphery of the opening at the upstream end of the upstream annular portion 63A. The insertion portion 62 has a cylindrical shape the diameter of which is equal to the inner diameter of the exhaust conduit connecting portion 38 of the turbine housing 33. As shown in FIG. 2, the turbine connecting portion 61 is attached to the exhaust conduit connecting portion 38 by inserting the insertion portion 62 into the interior of the connecting annular portion 38B of the exhaust conduit connecting portion 38 and causing the end face of the second flare portion 63 to abut against the end face of the connecting annular portion 38B of the exhaust conduit connecting portion 38. In this state, the outer circumferential surface of the insertion portion 62 is in contact with the inner circumferential surface of the connecting annular portion 38B of the exhaust conduit connecting portion 38. The exhaust conduit connecting portion 38 and the turbine connecting portion 61 are joined together, for example, by welding, so that the turbine housing 33 and the exhaust conduit 60 are connected to each other.

As shown in FIG. 3, the sensor mount 65 has a cylindrical sensor mount main portion 66, which has a central axis L3 that is inclined by a predetermined angle θ with respect to the central axis L2 of the turbine connecting portion 61. In the extending direction of the central axis L3, the length of the upper part of the sensor mount main portion 66 is longer than the length of the lower part. The sensor mount main portion 66 has a first support lug portion 67 in the upper part. A sensor is attached to the first support lug portion 67. The first support lug portion 67 has a tubular shape that protrudes outward from the outer circumferential surface of the sensor mount main portion 66. The interior of the first support lug portion 67 communicates with the interior of the sensor mount main portion 66. The first support lug portion 67 has a planar first support face 68 with an opening and a first support side face 69 extending from the periphery of the first support face 68. The first support face 68 includes an annular face portion 68A and a sectoral face portion 68B, which is located on the upstream side with respect to the annular face portion 68A. The sectoral face portion 68B has a recessed shape with respect to the outer circumferential surface of the sensor mount main portion 66. Also, the annular face portion 68A has a shape that protrudes with respect to the outer circumferential surface of the sensor mount main portion 66. The annular face portion 68A and the sectoral face portion 68B are arranged on the same plane. The first support lug portion 67 is configured such that the protruding amount from the outer circumferential surface of the sensor mount main portion 66 increases toward the downstream side. The first support face 68 is inclined with respect to the outer circumferential surface of the sensor mount main portion 66. Therefore, the length of the first support side face 69 in the extending direction from the first support face 68 increases toward the downstream side. The first support face 68 of the first support lug portion 67 has the above-described configuration. Thus, when a first sensor 171 is attached to the first support lug portion 67, and the distal end of the first sensor 171 Is arranged in the interior of the sensor mount main portion 66 as shown in FIG. 2, the distal end of the first sensor 171 is inclined toward the downstream side. Also, since the sectoral face portion 68B is recessed with respect to the outer circumferential surface of the sensor mount main portion 66, the inclination of the first sensor 171 is permitted while limiting the protruding amount of the first support lug portion 67. As shown in FIG. 3, the first support side face 69 has a thinned portion 70, which is located on the downstream side. The thinned portion 70 has a cutout shape and is located at the proximal end close to the sensor mount main portion 66. The thinned portion 70 has an upright face 70A, which extends in the extending direction of the first support side face 69, and an orthogonal face 70B, which extending in a direction orthogonal to the upright face 70A.

The sensor mount 65 has a sensor large-diameter portion 71, which is provided on the downstream side of the sensor mount main portion 66. The sensor large-diameter portion 71 has a cylindrical shape that extends in the extending direction of the central axis L3. The outer diameter of the sensor large-diameter portion 71 is larger than the outer diameter of the sensor mount main portion 66.

The first catalyst support portion 75 has a cylindrical shape that extends in the extending direction of the central axis L3. The outer diameter of the first catalyst support portion 75 is smaller than the outer diameter of the sensor mount main portion 66 of the sensor mount 65. The first catalyst support portion 75 accommodates a catalyst (not shown) for purifying exhaust gas. The bracket 80 is fixed to the lower part of the first catalyst support portion 75. The bracket 80 has a plate-shape and includes a bracket base 81, which is connected to the first catalyst support portion 75, and a bracket connecting portion 82, which extends from the bracket base 81. The bracket connecting portion 82 extends rightward with respect to the bracket base 81. That is, the bracket 80 has an L-shape when viewed from the rear of the vehicle. The bracket connecting portion 82 an elliptic or oblong connecting hole 82A, which extends in the vehicle width direction, at the left end.

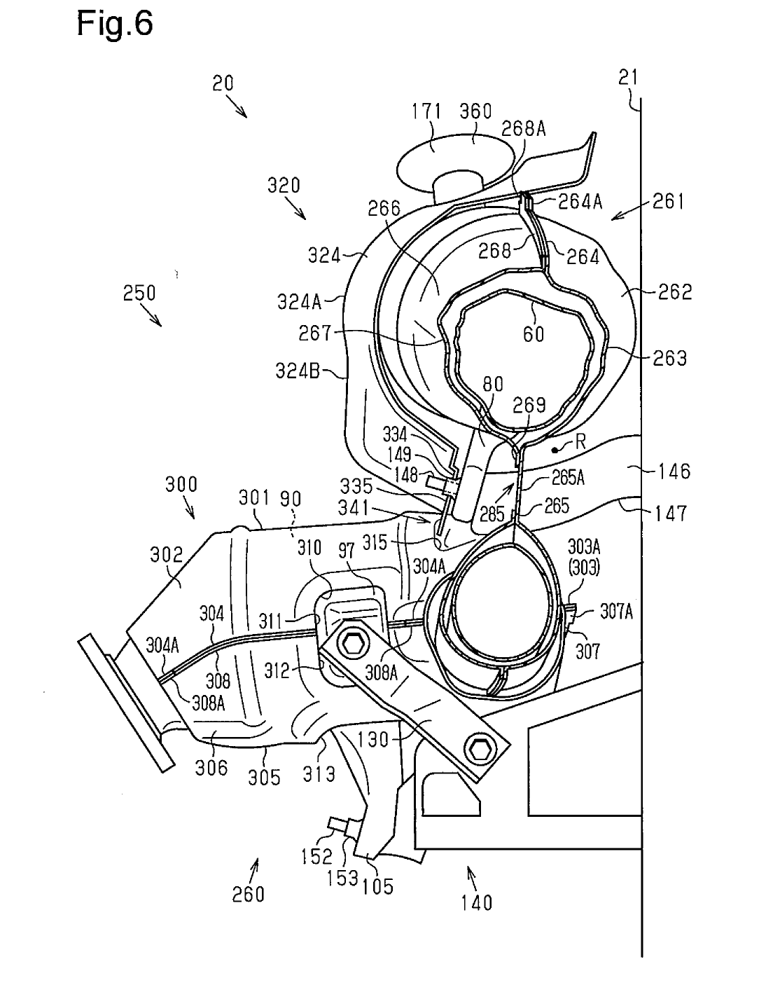

As shown in FIG. 6, the front end face of the bracket 80 abuts against a second stay 146, which is provided on the rear face of the engine body 21 of the internal combustion engine 20. The rear face of the engine body 21 is the surface of the engine body 21 that is located on the rear side or faces rearward in the vehicle front-rear direction. The second stay 146 has a second base 147, which extends rearward from the rear face of the engine body 21. The second base 147 is curved into an S-shape in the right side view of the internal combustion engine 20 so as to descend toward the rear end. Thus, the front end of the second base 147 is located above the rear end of the second base 147. The second base 147 is located below the first catalyst support portion 75 and above a lateral conduit portion 88C of the curved shape portion 85, which will be discussed below. A columnar second support pillar 148 extends rearward from the rear end face of the second base 147. The second support pillar 148 is inserted through the connecting hole 82A of the bracket 80.

When attaching the exhaust conduit 60 to the engine body 21, the second support pillar 148 of the second stay 146 is first inserted through the connecting hole 82A of the bracket 80. The center of gravity of the whole exhaust conduit 60 is present at a position different from the bracket 80. Thus, when the second support pillar 148 is inserted through the connecting hole 82A, so that the exhaust conduit 60 is supported by the second support pillar 148, the exhaust conduit 60 is inclined due to its own weight, so that the opening of the turbine connecting portion 61 faces the opening of the exhaust conduit connecting portion 38 of the turbine housing 33. By attaching the second nut 149 to the second support pillar 148, the bracket 80 is fastened to the second stay 146. As a result, the exhaust conduit 60 is attached to the engine body 21. The thickness of the bracket 80 is greater than that of the exhaust conduit 60.

As shown in FIG. 3, the curved shape portion 85 includes a cylindrical first curved conduit 86, a tubular second support lug portion 87, which protrudes from the outer circumferential surface of a first curved portion 86B, and a second curved conduit 88, which is provided on the downstream side of the first curved conduit 86. The first curved conduit 86 includes an upstream flare portion 86A, which is connected to the first catalyst support portion 75, and the first curved portion 86B, which is provided on the downstream side of the upstream flare portion 86A.

The inner diameter of the upstream end of the upstream flare portion 86A is equal to the outer diameter of the first catalyst support portion 75. When the right end of the first catalyst support portion 75 is inserted into the interior of the upstream flare portion 86A, the inner circumferential surface of the upstream flare portion 86A and the outer circumferential surface of the right end of the first catalyst support portion 75 come into contact. In this state, the curved shape portion 85 and the first catalyst support portion 75 are joined together, for example, by welding, so that the curved shape portion 85 and the first catalyst support portion 75 are connected to each other. The upper part of the outer circumferential surface of the upstream flare portion 86A is recessed downward, so that the upstream flare portion 86A has a shape the diameter of which decreases toward the downstream side. The first curved portion 86B is curved such that the end on the downstream side opens downward. That is, the first curved portion 86B causes exhaust gas flowing in the extending direction of the central axis L3 to flow downward.

The second support lug portion 87 extends upward from the outer circumferential surface on the upper side of the first curved portion 86B. The second support lug portion 87 has a cylindrical shape. The interior of the second support lug portion 87 communicates with the interior of the first curved portion 86B. As shown in FIG. 2, a second sensor 172 is attached to the second support lug portion 87. As shown in FIG. 3, the second support lug portion 87 has a planar second support face 87A, which has an opening, and a second support side face 87B, which extends from the periphery of the second support face 87A. The extending direction of the central axis of the second support lug portion 87 coincides with the up-down direction. Therefore, when the second sensor 172 is attached to the second support lug portion 87 and the distal end of the second sensor 172 is arranged in the interior of the first curved portion 86B, the distal end of the second sensor 172 faces downstream.

The cylindrical second curved conduit 88 includes a lower conduit portion 88A, which extends downward, a second curved portion 88B, which is provided on the downstream side of the lower conduit portion 88A, and a lateral conduit portion 88C, which is provided on the downstream side of the second curved portion 88B. The inner diameter of the lower conduit portion 88A is equal to the outer diameter of the end on the downstream side of the first curved portion 86B. When the end on the downstream side of the first curved portion 86B is inserted into the interior of the lower conduit portion 88A, the inner circumferential surface of the lower conduit portion 88A and the outer circumferential surface of the first curved portion 86B come into contact. In this state, the lower conduit portion 88A and the first curved portion 86B are joined together, for example, by welding, so that the second curved conduit 88 and the first curved conduit 86 are connected to each other. The second curved portion 88B is curved such that the end on the downstream side opens leftward. That is, the second curved portion 88B causes the exhaust gas flowing downward from the first curved portion 86B toward the lower conduit portion 88A to flow leftward in the vehicle width direction. The lateral conduit portion 88C has a cylindrical shape that extends in the vehicle width direction. The first curved conduit 86 and the second curved conduit 88 are arranged in the up-down direction. As described above, the curved shape portion 85 has a curved shape causes the flow of exhaust gas flowing through the first catalyst support portion 75 and rightward to flow downward first and then leftward. As shown in FIG. 2, the right end of the curved shape portion 85 is located leftward of the right end of the engine body 21.

As shown in FIG. 3, the second catalyst support portion 90 includes an exhaust inflow portion 91, a catalyst accommodating portion 92, which is provided on the downstream side of the exhaust inflow portion 91, and a support flare portion 108. The inner diameter of the end on the upstream side of the exhaust inflow portion 91 is equal to the outer diameter of the lateral conduit portion 88C of the second curved conduit 88. When the lateral conduit portion 88C is inserted into the interior of the exhaust inflow portion 91, the inner circumferential surface of the exhaust inflow portion 91 contacts the outer circumferential surface of the lateral conduit portion 88C. In this state, the exhaust inflow portion 91 and the lateral conduit portion 88C are joined together, for example, by welding, so that the second catalyst support portion 90 and the curved shape portion 85 are connected to each other. The exhaust inflow portion 91 has a shape the diameter of which increases toward the downstream side. In addition, as shown in FIG. 2, in the rear view of the internal combustion engine from the rear, the exhaust inflow portion 91 has a shape bulging upward, that is, towards the turbine housing 33. The exhaust inflow portion 91 extends leftward from the second curved conduit 88 and is arranged across the first center line L1. As shown in FIGS. 2 and 3, the exhaust inflow portion 91 has a curved shape such that the end on the downstream side is located at the rear. The exhaust inflow portion 91 causes the exhaust gas flowing leftward to flow toward the rear.

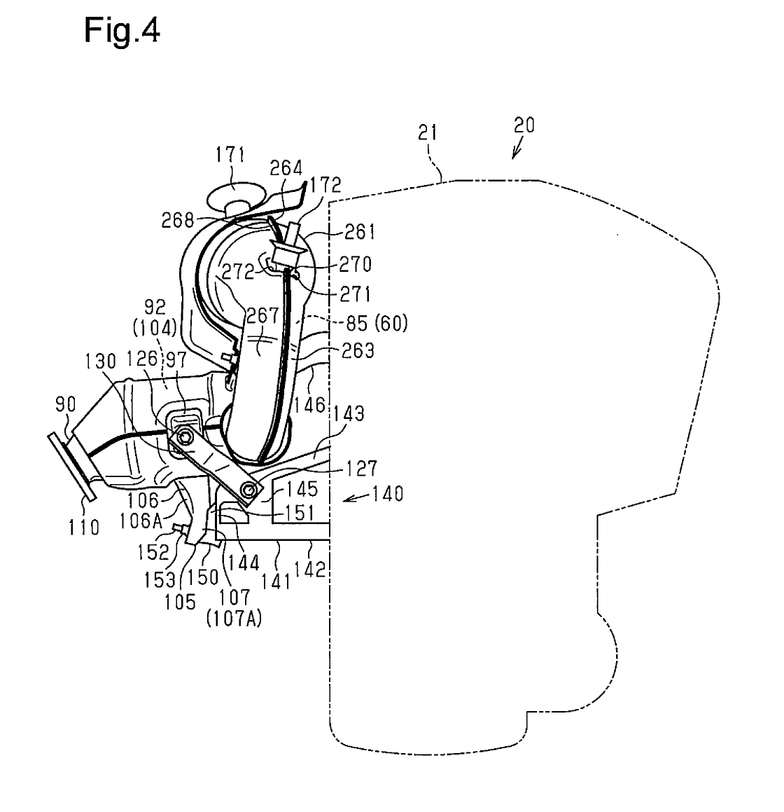

The catalyst accommodating portion 92 includes a cylindrical accommodating main conduit 104, which extends rearward, a first fixing lug 93, which extends from the outer circumferential surface of the accommodating main conduit 104, a second fixing lug 97, and a third fixing lug 105 shown in FIG. 4. The accommodating main conduit 104 accommodates a catalyst for purifying exhaust gas. The outer diameter of the accommodating main conduit 104 is equal to the outer diameter of the end on the downstream side of the exhaust inflow portion 91. As shown in FIG. 2, the accommodating main conduit 104 is inclined so as to descent toward the downstream side and is arranged on the first center line L1.

As shown in FIGS. 2 and 3, the first fixing lug 93 is arranged on the left side with respect to the accommodating main conduit 104. The first fixing lug 93 includes a rectangular plate-shaped first fixing wall portion 94, which has a bolt insertion hole 94A, and a pair of first side wall portions 95, which extend from two opposite edges of the first fixing wall portion 94. A nut (not shown) is welded to the front end face of the first fixing wall portion 94. The threaded hole of the nut is coaxial with the bolt insertion hole 94A. The first side wall portions 95 have a triangular plate shape in a right side view. The two first side wall portions 95 each include a first upper wall portion 95A, extends forward from the upper edge of the first fixing wall portion 94, and a first lower wall portion 95B, which extends forward from the lower edge of the first fixing wall portion 94. The first fixing lug 93 includes a first joining wall portion 96. The first joining wall portion 96 extends from the edges of the first fixing wall portion 94 and the pair of first side wall portions 95 adjacent to the accommodating main conduit 104. The first joining wall portion 96 extends outward from the first fixing wall portion 94, the first upper wall portion 95A, and the first lower wall portion 95B and along the outer circumferential surface of the accommodating main conduit 104. The first joining wall portion 96 is joined to the outer circumferential surface of the accommodating main conduit 104, for example, by welding.

As shown in FIG. 2, a first fastening plate 120 is fastened to the first fixing lug 93 with a bolt. The first fastening plate 120 includes a first plate portion 121, which extends in the up-down direction, a second plate portion 122, which extend rightward from the lower end of the first plate portion 121, and a third plate portion 123, which extends downward from the right end of the second plate portion 122. The first plate portion 121 abuts against the first fixing wall portion 94 of the first fixing lug 93. The first plate portion 121 has a bolt insertion hole. A first bolt 124 is inserted through the bolt insertion hole and fastened to the nut welded to the first fixing wall portion 94 while being passed through the bolt insertion hole 94A of the first fixing wall portion 94. Accordingly, the first fastening plate 120 is fixed to the first fixing lug 93. The third plate portion 123 has a bolt insertion hole. A second bolt 125 is inserted through the bolt insertion hole and is fastened to the rear face of the engine body 21, so that the first fastening plate 120 is fixed to the engine body 21.

As shown in FIGS. 2 and 3, the second fixing lug 97 is arranged on the right side with respect to the accommodating main conduit 104. The second fixing lug 97 includes a rectangular plate-shaped second upper wall portion 98, which is arranged on the upper side, and a rectangular plate-shaped second lower wall portion 99, which is arranged on the lower side, which is opposite to the second upper wall portion 98. The second fixing lug 97 also includes a rectangular plate-shaped second rear wall portion 100, which is arranged on the rear side, and a rectangular plate-shaped second front wall portion 101, which is arranged on the front side, which is opposite to the second rear wall portion 100. The right side edges of the second upper wall portion 98, the second lower wall portion 99, the second rear wall portion 100, and the second front wall portion 101 are connected to the second right wall portion 102. The second right wall portion 102 has a bolt insertion hole (not shown). A nut (not shown) is welded to the left end face of the second right wall portion 102. The threaded hole of the nut is coaxial with the bolt insertion hole of the second right wall portion 102. The second fixing lug 97 includes a second joining wall portion 103. The second joining wall portion 103 extends from the edges of the second upper wall portion 98, the second lower wall portion 99, the second rear wall portion 100, and the second front wall portion 101 that are adjacent to the accommodating main conduit 104. The second joining wall portion 103 extends outward from the second upper wall portion 98, the second lower wall portion 99, the second rear wall portion 100, and the second front wall portion 101 and along the outer circumferential surface of the accommodating main conduit 104. The second joining wall portion 103 is joined to the outer circumferential surface of the accommodating main conduit 104, for example, by welding.

As shown in FIG. 4, a second fastening plate 130 is fastened to the second fixing lug 97 with a bolt. The second fastening plate 130 has a rectangular shape. The second fastening plate 130 is inclined so as to descend toward the front. The second fastening plate 130 has a bolt insertion hole at the rear end. A third bolt 126 is inserted through the bolt insertion hole and the bolt insertion hole of the second right wall portion 102 and is screwed to the nut welded to the second right wall portion 102. Accordingly, the second fastening plate 130 is fixed to the second fixing lug 97. Also, the second fastening plate 130 has a bolt insertion hole at the front end. A bolt 127 is inserted through the bolt insertion hole and is fastened to the side surface of a first stay 140 provided on the rear face of the engine body 21. Accordingly, the second fastening plate 130 is fixed to the engine body 21. The first stay 140 has a first base 141, which extends rearward from the rear face of the engine body 21. The first base 141 includes a lower leg portion 142, which extends horizontally rearward from the engine body 21, and an upper leg portion 143, which is located above the lower leg portion 142 and extends rearward from the engine body 21 while being inclined with respect to a horizontal plane. The upper leg portion 143 extends rearward and obliquely downward. The rear end of the lower leg portion 142 and the rear end of the upper leg portion 143 are connected by a connecting leg portion 144, which extends in the up-down direction. Also, the center of the lower leg portion 142 and the center of the upper leg portion 143 are connected by a reinforcing leg portion 145, which extends in the up-down direction. The second fastening plate 130 is fastened to the side of the reinforcing leg portion 145.

The first stay 140 includes a stay portion 150, which extends rearward from the rear end face of the first base 141, that is, from the rear end faces of the lower leg portion 142 and the connecting leg portion 144. The stay portion 150 has a triangular base 151, which has a triangular shape as viewed from the right side of the vehicle. The lower end of the triangular base 151 is located below the lower leg portion 142 of the first base 141. The lower end face of the triangular base 151 extends toward the rear of the engine body 21. The upper end face of the triangular base 151 is inclined so as to descend toward the rear end. The stay portion 150 has a columnar first support pillar 152, which extends rearward from the triangular base 151.

The third fixing lug 105, which is provided on the second catalyst support portion 90 extends downward from the accommodating main conduit 104. As shown in FIG. 2, the third fixing lug 105 has a third rear wall portion 106, which has an elongated rectangular shape extending in the up-down direction. As shown in FIG. 4, the third rear wall portion 106 is curved so that the center portion in the up-down direction protrudes forward. The lower end of the third rear wall portion 106 is located below the first base 141 of the first stay 140. As shown in FIGS. 2 and 4, the third rear wall portion 106 has a protrusion 106A at the center portion in the vehicle width direction. The protrusion 106A protrudes rearward and extends in the up-down direction. The third rear wall portion 106 has a pair of third side wall portions 107, which extend forward from the opposite ends in the vehicle width direction. The pair of third side wall portions 107 includes a third right wall portion 107A, which is located on the right side, and a third left wall portion 107B, which is located on the left side, which is opposite to the third right wall portion 107A. As shown in FIG. 4, the front ends of the pair of third side wall portions 107 are arranged rearward of the first base 141 of the first stay 140. As shown in FIGS. 2 and 4, the third rear wall portion 106 has a through-hole at the lower end, and the first support pillar 152 of the first stay 140 is passed through the through-hole. A first nut 153, which is screwed to the first support pillar 152, fastens the third fixing lug 105 to the first stay 140.

As shown in FIG. 3, the support flare portion 108 has a cylindrical shape the diameter of which decreases the downstream side. As shown in FIG. 2, the support flare portion 108 is inclined so as to descent toward the downstream side and is arranged on the first center line L1.

As shown in FIG. 3, the exhaust pipe connecting portion 110 has a flat plate shape. The exhaust pipe connecting portion 110 includes a first abutting annular portion 111, which is connected to the downstream end of the second catalyst support portion 90, and a pair of first extended flange portions 112, which is provided on the opposite ends in the vehicle width direction of the first abutting annular portion 111. The first abutting annular portion 111 has an annular recess 111A extending around the opening at the downstream end face. The pair of first extended flange portions 112 includes a first right flange portion 112A, which extends rightward from the first abutting annular portion 111, and a first left flange portion 112B, which extends leftward from the first abutting annular portion 111. The first right flange portion 112A and the first left flange portion 112B are arranged at an angular interval of 180° in the circumferential direction. The first right flange portion 112A and the first left flange portion 112B have a shape that tapers as the distance from the first abutting annular portion 111 increases. When the exhaust conduit 60 is attached to the turbine housing 33 and the engine body 21 as shown in FIG. 2, the first right flange portion 112A is arranged below the first left flange portion 112B. As shown in FIG. 4, each of the first right flange portion 112A and the first left flange portion 112B has a first bolt insertion hole 113. A fastening bolt 115 is inserted through each first bolt insertion hole 113. As shown in FIG. 2, the opening of the first abutting annular portion 111 is arranged on the first center line L1.

As shown in FIG. 1, an exhaust pipe 160 is connected to the downstream end of the exhaust conduit 60. The exhaust pipe 160 includes a front pipe 161, a center pipe (not shown), and a tail pipe (not shown). The front pipe 161 has a connecting flange portion 162, which is connected to the exhaust pipe connecting portion 110, a diameter reduction pipe 165, which is provided on the downstream side of the connecting flange portion 162, a first pipe 166, which is provided on the downstream side of the diameter reduction pipe 165, and a second pipe 167, which is provided on the downstream side of the first pipe 166.

The connecting flange portion 162 has a flat plate shape the outer shape of which is the same as the outer shape of the exhaust pipe connecting portion 110. The thickness of the connecting flange portion 162 is equal to the thickness of the exhaust pipe connecting portion 110. The connecting flange portion 162 has a second abutting annular portion 163 and a pair of second extended flange portions 164, which are provided at the opposite ends in the vehicle width direction of the second abutting annular portion 163. The pair of second extended flange portions 164 includes a second right flange portion 164A, which extends rightward from the second abutting annular portion 163, and a second left flange portion 164B, which extends leftward from the second abutting annular portion 163. The second right flange portion 164A and the second left flange portion 164B are arranged at an angular interval of 180° in the circumferential direction. The second right flange portion 164A and the second left flange portion 164B have a shape that tapers as the distance from the second abutting annular portion 163 increases. Each of the second right flange portion 164A and the second left flange portion 164B has a second bolt insertion hole 168. The second abutting annular portion 163 contacts the first abutting annular portion 111, the second right flange portion 164A contacts the first right flange portion 112A, and the second left flange portion 164B contacts the first left flange portion 112B. Then, nuts (not shown) are screwed to the fastening bolts 115 inserted through the first bolt insertion holes 113 and the second bolt insertion holes 168 to fasten the exhaust pipe connecting portion 110 and the connecting flange portion 162 to each other, so that the front pipe 161 is connected to the exhaust conduit 60.

The diameter reduction pipe 165, which has a cylindrical shape, extends from the periphery of the opening in the second abutting annular portion 163 of the connecting flange portion 162. The diameter of the diameter reduction pipe 165 decreases toward the downstream side. The first pipe 166 has a cylindrical shape. The first pipe 166 has a constant outer diameter equal to that at the downstream end of the diameter reduction pipe 165. The first pipe 166 is arranged to descend toward the downstream side. The second pipe 167 has a cylindrical shape. The outer diameter of the second pipe 167 is equal to the inner diameter of the first pipe 166. When the upstream end the second pipe 167 is inserted into the interior of the first pipe 166, the inner circumferential surface of the first pipe 166 and the outer circumferential surface of the second pipe 167 come into contact with each other. In this state, the first pipe 166 and the second pipe 167 are joined to each other, for example, by welding. The upstream end of the second pipe 167 is located in the engine compartment 10, and the second pipe 167 extends outward from the engine compartment 10. The second pipe 167 extends to the bottom of the vehicle through under the dashboard (not shown). In the lower part of the vehicle, the downstream end of the second pipe 167 is connected to the center pipe. The downstream end of the center pipe is connected to the tail pipe. The tail pipe opens at the rear end of the vehicle. The exhaust gas discharged from the engine body 21 to the turbine housing 33 passes through the exhaust conduit 60 and the exhaust pipe 160 and is emitted to the outside of the vehicle.

In the present embodiment, the turbine housing 33 of the forced-induction device 30, the exhaust conduit 60, which is connected to the downstream end of the turbine housing 33, and the exhaust pipe 160 constitute the exhaust conduit member in the exhaust system apparatus of the internal combustion engine. Also, as shown in FIG. 2, the turbine connecting portion 61 of the exhaust conduit 60, the sensor mount 65, the first catalyst support portion 75, the curved shape portion 85, and the second catalyst support portion 90 constitute the curved portion of the exhaust conduit member. The curved portion is curved into a U-shape such that the flow of exhaust gas flowing rightward is directed downward and then leftward. In the rear view of the internal combustion engine 20 as viewed from the rear of the vehicle, the region surrounded by the turbine connecting portion 61, the sensor mount 65, the first catalyst support portion 75, the curved shape portion 85, and the second catalyst support portion 90 is a region R on the inner peripheral side of the curved portion. The bracket 80 of the exhaust conduit 60 is arranged in the region R on the inner peripheral side of the curved portion. The region R on the inner peripheral side of the curved portion will hereafter be referred to as an inner peripheral region R. Also, the region on the outer peripheral side of the curved portion will hereafter be referred to as an outer peripheral region.

In the rear view shown in FIG. 2, the exhaust conduit member is arranged in the region surrounded by the outer periphery of the engine body 21 in the up-down direction and the vehicle width direction. Therefore, as viewed from the rear of the vehicle, the exhaust conduit member is entirely located within the region of the rear face of the engine body 21.

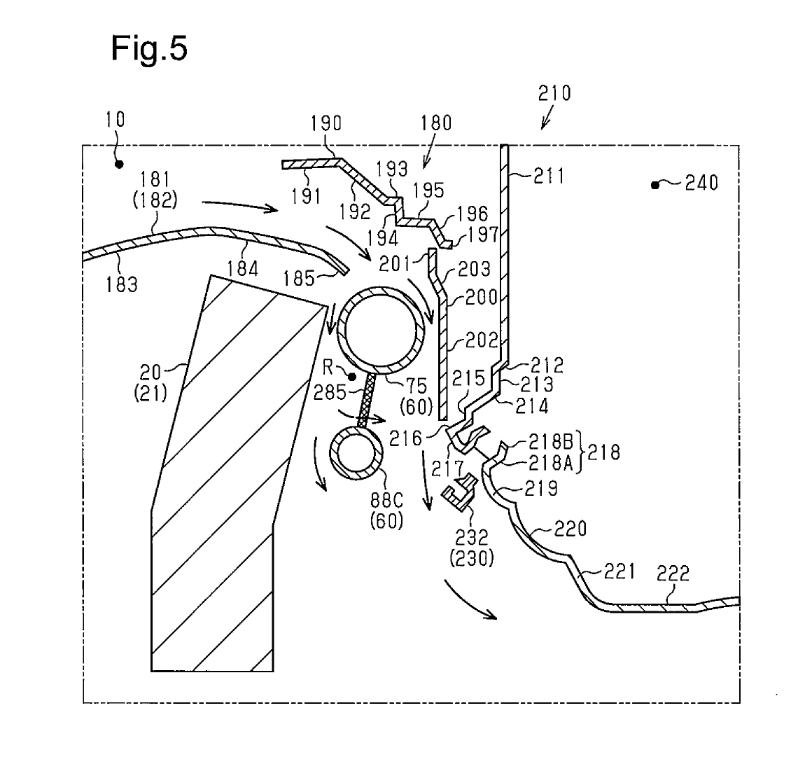

As shown in FIG. 5, an air guide plate 180 is provided in the engine compartment 10. The air guide plate 180 guides relative wind to the exhaust conduit 60 and the turbine housing 33. The air guide plate 180 includes, as components, an air guide cover 181, which covers the upper part of the engine body 21, an upper cover 190, which is arranged above the air guide cover 181, and a rear cover 200, which is arranged in the vicinity of the rear end of the upper cover 190.

As shown in FIGS. 1 and 5, the air guide cover 181 includes a cover main body 182, which has a plate shape. The cover main body 182 is arranged above the upper end of the engine body 21. The cover main body 182 includes a front body portion 183, which is located on the front side, a middle body portion 184, which is provided rearward of the front body portion 183, and a rear body portion 185, which is provided rearward of the middle body portion 184. As shown in FIG. 5, the front body portion 183 extends to a position forward of the front end of the engine body 21. The front body portion 183 is inclined so as to ascend toward the rear end. The middle body portion 184 is inclined so as to descend toward the rear end. The rear body portion 185 extends obliquely downward from the rear end of the middle body portion 184. The degree of inclination of the rear body portion 185 is greater than the degree of inclination of the middle body portion 184. The rear end of the rear body portion 185 is arranged rearward of the rear end of the engine body 21. The rear end of the rear body portion 185 extends to a position directly above the exhaust conduit 60.

As shown in FIG. 1, the air guide cover 181 includes a plate-shaped right-side wall cover 186 and a plate-shaped left-side wall cover 187, which are provided at the opposite ends in the vehicle width direction of the cover main body 182. The right-side wall cover 186 extends upward from the right end of the cover main body 182. The right-side wall cover 186 is provided continuously from the front end to the rear end of the cover main body 182. In the right-side wall cover 186, the height of the center portion extending upward from the boundary between the front body portion 183 and the middle body portion 184 is the lowest, and the height from the cover main body 182 increases toward the front side and thereafter side. That is, the right-side wall cover 186 is configured such that the height of the portion extending upward from the middle body portion 184 is lower than the height of the portion extending upward from the rear body portion 185.

The left-side wall cover 187 extends upward from the left end of the cover main body 182. The left-side wall cover 187 is provided continuously from the front end to the rear end of the cover main body 182. In the left-side wall cover 187, the height of the center portion extending upward from the boundary between the front body portion 183 and the middle body portion 184 is the lowest, and the height from the cover main body 182 increases toward the front side and thereafter side. That is, the left-side wall cover 187 is configured such that the upright height of the portion extending upward from the middle body portion 184 is lower than the upright height of the portion extending upward from the rear body portion 185 in the cover main body 182. The right-side wall cover 186 and the left-side wall cover 187 restrict the movement in the vehicle width direction of the relative wind flowing over the cover main body 182.

As shown in FIG. 5, the upper cover 190 has a plate shape and extends in the vehicle width direction (the direction along the depth of the sheet of FIG. 5). The length in the vehicle width direction of the upper cover 190 is equal to the length in the vehicle width direction of the air guide cover 181. The upper cover 190 includes an upper end cover portion 191, which is located on the front side, and a first inclined cover portion 192, which extends obliquely downward from the rear end of the upper end cover portion 191. The front end of the upper end cover portion 191 is located above the middle body portion 184 in the cover main body 182, and the rear end of the upper end cover portion 191 is arranged above the rear body portion 185. The first inclined cover portion 192 is inclined so as to descend toward the rear side. The rear end of the first inclined cover portion 192 is located rearward of the lateral conduit portion 88C of the exhaust conduit 60 and above the first catalyst support portion 75.

The upper cover 190 includes a first horizontal cover portion 193, which extends horizontally rearward from the rear end of the first inclined cover portion 192, and a vertical cover portion 194, which extends downward from the rear end of the first horizontal cover portion 193. The lower end of the vertical cover portion 194 is arranged at the same position in the up-down direction as the upper end of the cover main body 182 in the air guide cover 181. The upper cover 190 has a second horizontal cover portion 195, which extends horizontally rearward from the lower end of the vertical cover portion 194. The lower end face of the second horizontal cover portion 195 is arranged at the same position in the up-down direction as the upper end of the cover main body 182. Also, the rear end of the second horizontal cover portion 195 is located rearward of the first catalyst support portion 75 of the exhaust conduit 60. The upper cover 190 includes a second inclined cover portion 196, which extends diagonally downward from the rear end of the second horizontal cover portion 195, and a third horizontal cover portion 197, which extends horizontally rearward from the rear end of the second inclined cover portion 196. The lower end of the third horizontal cover portion 197 is located above the rear body portion 185 of the cover main body 182.

A rear cover 200 has a plate shape that extends an adequate length in the vehicle width direction. The rear cover 200 is arranged rearward of the first catalyst support portion 75 of the exhaust conduit 60. The rear cover 200 includes a first upright cover portion 201, which extends in the up-down direction, a second upright cover portion 202, which is arranged below and rearward of the first upright cover portion 201 and extends in the up-down direction, and a rear inclined cover portion 203, which connects the rear end of the first upright cover portion 201 and the upper end of the second upright cover portion 202.

The upper end of the first upright cover portion 201 is located at the same position in the up-down direction as the lower end of the third horizontal cover portion 197 of the upper cover 190. Also, the first upright cover portion 201 is located below the second inclined cover portion 196 and is arranged forward of the third horizontal cover portion 197. The lower end of the first upright cover portion 201 is arranged at the same position in the up-down direction as the lower end of the rear body portion 185 of the cover main body 182. The rear inclined cover portion 203 is inclined so as to descend toward the rear end. The lower end of the rear inclined cover portion 203 is located below the upper end of the first catalyst support portion 75 of the exhaust conduit 60. The lower end of the second upright cover portion 202 is arranged between the first catalyst support portion 75 and the lateral conduit portion 88C of the exhaust conduit 60 in the up-down direction.

A dashboard 210 is provided on the rear side of the air guide cover 181, the upper cover 190, and the rear cover 200. The dashboard 210 separates the engine compartment 10 and the passenger compartment 240 from each other. The dashboard 210 has a partition wall portion 211, which extends in the up-down direction. The partition wall portion 211 extends from a position above the upper cover 190 to a position of the same height as the lower end of the first catalyst support portion 75 of the exhaust conduit 60. The dashboard 210 has a first inclined wall 212, which extends obliquely downward from the lower end of the partition wall portion 211. The first inclined wall 212 is inclined so as to be progressively shifted to the front toward the lower end. The dashboard 210 has a first upright wall 213, which extends downward from the lower end of the first inclined wall 212. The first upright wall 213 extends to a position below the first catalyst support portion 75. The dashboard 210 has a second inclined wall 214, which extends downward from the lower end of the first upright wall 213. The second inclined wall 214 is inclined so as to be progressively shifted to the front toward the lower end. The dashboard 210 has a second upright wall 215, which extends downward from the lower end of the second inclined wall 214. The second upright wall 215 extends to a position below the rear cover 200. The dashboard 210 has a third inclined wall 216, which extends downward from the lower end of the second upright wall 215. The third inclined wall 216 is inclined so as to be progressively shifted to the front toward the lower end. The third inclined wall 216 extends to a position forward of the rear end face of the second upright cover portion 202 of the rear cover 200. The dashboard 210 has a fourth inclined wall 217, which extends downward from the lower end of the third inclined wall 216. The fourth inclined wall 217 is inclined so as to be progressively shifted to the rear toward the lower end. The dashboard 210 has a cylindrical wall portion 218, which protrudes from the lower end of the fourth inclined wall 217 toward the passenger compartment 240. The cylindrical wall portion 218 includes a flare tube portion 218A, the diameter of which increases toward the passenger compartment 240, and a flare tube portion 218B, which extends from the flare tube portion 218A such that the diameter decreases toward the passenger compartment 240.

The dashboard 210 has a first curved wall 219, which extends downward in a curved manner from the lower end of the cylindrical wall portion 218. The first curved wall 219 is curved so as to protrude toward the engine compartment 10, and the lower end of the first curved wall 219 is located rearward of the upper end of the first curved wall 219. The first curved wall 219 extends to a position below the lateral conduit portion 88C of the exhaust conduit 60. The dashboard 210 has a second curved wall 220, which extends downward in a curved manner from the lower end of the first curved wall 219, and a third curved wall 221, which extends downward in a curved manner from the lower end of the second curved wall 220. The second curved wall 220 is curved so as to protrude toward the engine compartment 10, and the lower end of the second curved wall 220 is located rearward of the upper end of the second curved wall 220. Also, the third curved wall 221 is curved so as to protrude toward the engine compartment 10, and the lower end of the third curved wall 221 is located rearward of the upper end of the third curved wall 221. A floor panel 222 extends rearward from the lower end of the third curved wall 221. The exhaust pipe 160 described above passes under the floor panel 222 and extends rearward.

As shown in FIG. 1, the vehicle has a steering apparatus 230. The steering apparatus 230 includes a steering wheel (not shown), which is arranged in the passenger compartment 240, and a steering shaft 231, which is connected to the steering wheel. The steering shaft 231 extends from the passenger compartment 240 to the engine compartment 10 through the cylindrical wall portion 218 of the dashboard 210. As shown in FIGS. 1 and 5, the steering apparatus 230 has a joint bushing 232, which is attached to a portion of the steering shaft 231 that is located in the engine compartment 10. The joint bushing 232 is made of an elastic material such as rubber. As shown in FIG. 5, the joint bushing 232 is arranged forward of the first curved wall 219 of the dashboard 210 and rearward of the front end face of the second upright cover portion 202 of the rear cover 200. The joint bushing 232 is arranged rearward of the curved portion of the exhaust conduit 60.

As indicated by the arrows in FIG. 5, the air flow of relative wind is conducted into to the space above the air guide cover 181 when the vehicle is traveling. The air flow of relative wind flows to the rear of the engine body 21 along the air guide cover 181 and flows between the air guide cover 181 and the upper cover 190. Since the middle body portion 184 and the rear body portion 185 of the air guide cover 181 are inclined downward, the relative wind is guided downward along these inclinations. Also, the air flow of relative wind is guided downward by colliding with the upper cover 190 and the rear cover 200. Thus, the air flow guided by the air guide plate 180 flows downward by passing around the turbine housing 33 and the exhaust conduit 60. As the heat is conducted away by the air flow, the temperature rise of the turbine housing 33 and the exhaust conduit 60 is suppressed.

As shown in FIG. 2, the exhaust system apparatus of the internal combustion engine has a heat shield member 250, which covers the exhaust conduit member. The heat shield member 250 has a function of suppressing transfer of heat radiated from the exhaust conduit member to the surrounding devices. The heat shield member 250 has an exhaust conduit-side insulator 260, which covers the exhaust conduit 60, and a turbine-side insulator 320, which covers the turbine housing 33. The exhaust conduit-side insulator 260 includes an upstream insulator 261, which covers a section of the exhaust conduit 60 from the sensor mount 65 to the curved shape portion 85, and a downstream insulator 300, which covers a section of the exhaust conduit 60 from the curved shape portion 85 to the second catalyst support portion 90. As shown in FIGS. 2 and 6, the upstream insulator 261 is constituted by joining and integrating a front split part 262, which is arranged on the front side, and a rear split part 266, which is arranged on the rear side.

As shown in FIG. 6, the front split part 262 includes a front covering portion 263, which is curved along the outer circumferential surface of the front semicircular portion of the exhaust conduit 60 to cover the front semicircular portion, and an outer front flange 264, which extends from the front covering portion 263 toward the outer peripheral region of the exhaust conduit 60. The front split part 262 also has an inner front flange 265, which extends from the front covering portion 263 toward the inner peripheral region R of the exhaust conduit 60.

The rear split part 266 includes a rear covering portion 267, which is curved along the outer circumferential surface of the rear semicircular portion of the exhaust conduit 60 to cover the rear semicircular portion, and an outer rear flange 268, which extends from the rear covering portion 267 toward the outer peripheral region of the exhaust conduit 60. The rear split part 266 also has an inner rear flange 269, which extends from the rear covering portion 267 toward the inner peripheral region R of the exhaust conduit 60. As shown in FIGS. 2 and 4, the upstream insulator 261 has a sensor opening 270, which is used to mount the second sensor 172 to the second support lug portion 87 provided in the curved shape portion 85 of the exhaust conduit 60. As shown in FIG. 4, the sensor opening 270 is configured by a first cutout 271, which is provided in the front covering portion 263, and a second cutout 272, which is provided in the rear covering portion 267 and connected to the first cutout 271. The outer front flange 264 is not provided in a part of the front split part 262 in which the sensor opening 270 is provided. Also, the outer rear flange 268 is not provided in a part of the rear split part 266 in which the sensor opening 270 is provided.

As shown in FIG. 2, the upstream insulator 261 has a bracket opening 275, which is used to expose the bracket 80, which extends downward from the outer circumferential surface of the first catalyst support portion 75 of the exhaust conduit 60. The bracket opening 275 is constituted by a cutout provided in the front covering portion 263 and a cutout provided in the rear covering portion 267.

As shown in FIGS. 2 and 6, the outer rear flange 268 has outer rear joint portions 268A. The extending length of each outer rear joint portion 268A in a direction away from the rear covering portion 267, that is, the protruding length from the rear covering portion 267 is partially increased. Each outer rear joint portions 268A has a rectangular plate shape. The outer rear joint portions 268A are each arranged in the outer peripheral region of the exhaust conduit 60, outside the first catalyst support portion 75, and outside the second curved conduit 88 of the curved shape portion 85. Also, the inner rear flange 269 has inner rear joint portions 269A. The extending length of each inner rear joint portion 269A in a direction away from the rear covering portion 267, that is, the protruding length from the rear covering portion 267 is partially increased. Each inner rear joint portions 269A has a rectangular plate shape. The inner rear joint portions 269A are each arranged in the inner peripheral region R of the exhaust conduit 60, inside the upstream flare portion 86A of the curved shape portion 85, and inside the lateral conduit portion 88C of the curved shape portion 85. The shape of the outer rear joint portions 268A is the same as the shape of the inner rear joint portions 269A.

As shown in FIG. 6, the outer front flange 264 has outer front joint portions 264A. The extending length of each outer front joint portion 264A in a direction away from the front covering portion 263, that is, the protruding length from the front covering portion 263 is partially increased. The outer front joint portions 264A have a rectangular plate shape and have the same shape and extending length as those of the outer rear joint portions 268A. The outer front joint portions 264A are each arranged in the outer peripheral region of the exhaust conduit 60, outside the first catalyst support portion 75, and outside the second curved conduit 88 of the curved shape portion 85. The outer front joint portions 264A are stacked on the outer rear joint portions 268A. As shown in FIGS. 2 and 6, the inner front flange 265 has an inner front joint film portion 265A. The extending length of the inner front joint film portion 265A in a direction away from the front covering portion 263, that is, the protruding length from the front covering portion 263 is partially increased. The inner front joint film portion 265A is located in the inner peripheral region R of the exhaust conduit 60 and extends continuously from the inside of the upstream flare portion 86A of the curved shape portion 85 to the inside of the lateral conduit portion 88C. The extending length of the inner front joint film portion 265A is longer than the extending length of the outer front joint portions 264A. That is, the extending length of the inner front joint film portion 265A is longer than the extending length of the outer rear joint portions 268A.

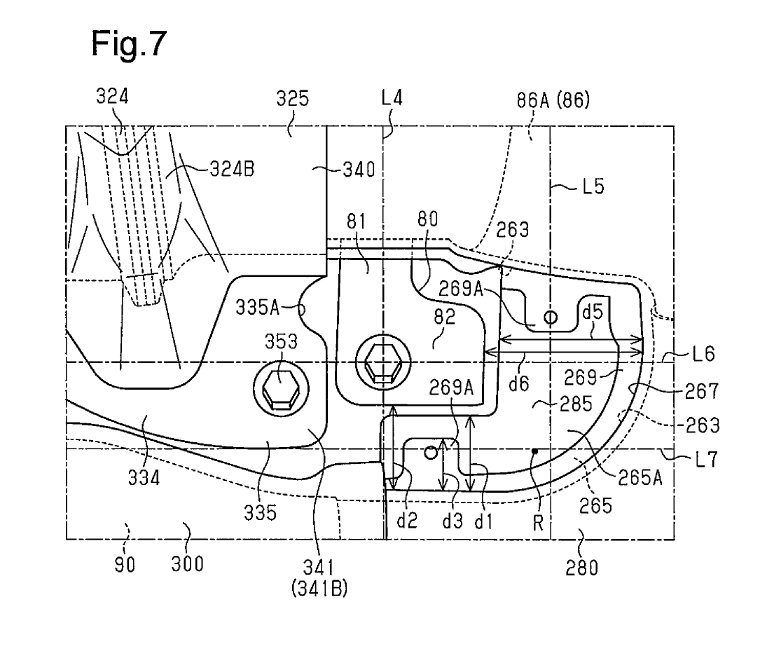

As shown in FIG. 7, the shape and position of the inner front joint film portion 265A are determined such that the inner front joint film portion 265A does not overlap with the bracket 80, which is arranged in the inner peripheral region R of the exhaust conduit 60, when viewed from the rear of the vehicle. That is, the extending length d1 (the length in the up-down direction in FIG. 7) of the portion of the inner front joint film portion 265A located below the bracket 80 is slightly shorter the length d2 in the up-down direction from the front covering portion 263 to the lower end face of the bracket connecting portion 82 (d1<d2). Thus, a clearance exists between the portion of the inner front joint film portion 265A that is arranged below the bracket 80 and the bracket 80. Further, the extending length d5 (the length in the left-right direction in FIG. 7) of a portion of the inner front joint film portion 265A that is arranged to the right of the bracket connecting portion 82 is slightly shorter than the length d6 in the left-right direction from the front covering portion 263 to the right end face of the bracket connecting portion 82 (d5<d6). Thus, a clearance exists between the bracket 80 and a portion of the inner front joint film portion 265A that is arranged to the right of the bracket connecting portion 82. In this way, the left end of the inner front joint film portion 265A has the same shape as the outer shape of the bracket 80, so that the inner front joint film portion 265A does not contact the bracket 80 when viewed from the rear of the vehicle, and a predetermined clearance is provided between the inner front joint film portion 265A and the bracket 80. The inner rear joint portions 269A stacked on the inner front joint film portion 265A. The extending length d3 (the length in the up-down direction in FIG. 7) of the inner rear joint portions 269A, which is arranged below the bracket 80, is shorter than the extending length d1 of the inner front joint film portion 265A, which is arranged in a portion overlapping with the inner rear joint portions 269A (d3<d1). Thus, the distance in the up-down direction from the inner rear joint portions 269A to the bracket 80 (d2−d3) is longer than the distance in the up-down direction from the inner front joint film portion 265A to the bracket 80 (d2−d1).

As shown in FIG. 6, the outer front flange 264 and the outer rear flange 268 have the same shape and are abutted against each other. In addition, the inner front flange 265 and the inner rear flange 269 have the same shape except for the portions where the inner rear joint portions 269A and the inner front joint film portions 265A are provided, and are abutted against each other. In this state, the entire circumference in the circumferential direction of the exhaust conduit 60 is covered with the front covering portion 263 of the front split part 262 and the rear covering portion 267 of the rear split part 266. A predetermined clearance is provided between the upstream insulator 261 and the exhaust conduit 60. A heat-resistant mat (not shown) is provided in the clearance. The heat-resistant mat is made of a heat-resistant fibrous material such as glass wool and is arranged over the entire circumference in the circumferential direction of the exhaust conduit 60. Since the heat-resistant mat is arranged between the upstream insulator 261 and the exhaust conduit 60, the upstream insulator 261 is kept apart from the exhaust conduit 60.

In such a state, the upstream insulator 261 is constituted by causing by joining the outer front joint portions 264A and the outer rear joint portions 268A to each other and joining the inner front joint film portions 265A and the inner rear joint portions 269A to each other. The proximal ends of the outer front joint portions 264A and the outer rear joint portions 268A are crimped together, and the distal ends are spot-welded together, so that the joint portions 264A and 268A are joined together. The extending lengths of the outer front joint portions 264A and the outer rear joint portions 268A are set to lengths required to join the front split part 262 and the rear split part 266 to constitute the upstream insulator 261. Likewise, the proximal ends of the inner front joint film portion 265A and the inner rear joint portions 269A are crimped together, and the distal ends are welded together, so that the inner front joint film portion 265A and the inner rear joint portions 269A are joined together. The extending length of the outer front joint portions 264A is set to a length required to join the front split part 262 and the rear split part 266 to constitute the upstream insulator 261. Also, the extending length of the inner front joint film portion 265A is set to be longer than the required length.

In the upstream insulator 261, the front covering portion 263 and the rear covering portion 267 constitute a curved-side body portion 280, which covers the curved portion. In the upstream insulator 261, the inner front flange 265 and the inner rear flange 269 constitute an inner flange portion 285, which extends from the curved-side body portion 280 and is arranged in the inner peripheral region R. As shown in FIG. 6, the thickness of the inner flange portion 285 is less than the thickness of the bracket 80. Also, in the upstream insulator 261, the outer front flange 264 and the outer rear flange 268 constitute an outer flange portion 290, which extends from the curved-side body portion 280 and is arranged in the outer peripheral region of the curved portion.

As shown in FIG. 7, in the portion of the inner front joint film portion 265A located below the upstream flare portion 86A, a first end (the upper end in FIG. 7) and a second end (FIG. 7) of the portion are connected to the front covering portion 263. That is, in the portion of the inner flange portion 285 located below the upstream flare portion 86A, both ends of the same portion in the direction of the extending length are connected to the curved-side body portion 280. In other words, sections of the exhaust conduit 60 that face each other in the U-shaped curved portion are connected together by the inner flange portion 285. Also, as shown in FIG. 2, the extending length of the inner front joint film portion 265A is longer than the extending lengths of the outer front joint portions 264A and the outer rear joint portions 268A. That is, the extending length of the inner flange portion 285 from the curved-side body portion 280 is longer than the extending length of the outer flange portion 290 from the curved-side body portion 280. Since the inner front joint film portion 265A is continuously provided from the inside of the upstream flare portion 86A of the curved shape portion 85 to the inside of the lateral conduit portion 88C, the inner flange portion 285 blocks the right end of the inner peripheral region R of the exhaust conduit 60.

As shown in FIG. 6, the inner diameter of the end on the upstream side of the downstream insulator 300 is larger than the outer diameter of the end on the downstream side of the upstream insulator 261. As shown in FIG. 2, in the flow direction of exhaust gas, the upstream end face of the downstream insulator 300 is arranged at the same position as the downstream end face of the upstream insulator 261. As shown in FIG. 6, the downstream insulator 300 is constituted by joining and integrating an upper split part 301, which is arranged on the upper side, and a lower split part 305, which is arranged on the lower side.

As shown in FIGS. 2 and 6, the upper split part 301 includes an upper covering portion 302, which is curved along the outer circumferential surface of the upper semicircular portion of the exhaust conduit 60 to cover the upper semicircular portion, a first upper flange 303, which extends along one of the edges of the upper covering portion 302, and a second upper flange 304, which extends along the other edge of the upper covering portion 302. The first upper flange 303 is located on the left side at the downstream end of the upper covering portion 302 and extends forward along the support flare portion 108 and the catalyst accommodating portion 92. Also, as shown in FIG. 6, the front part of the first upper flange 303 extends in the vehicle width direction (the direction along the depth of the sheet of FIG. 6) along the exhaust inflow portion 91. As shown in FIGS. 2 and 6, the first upper flange 303 has a first upper joint portion 303A at the front end and the rear end. The extending length of each first upper joint portion 303A in a direction away from the upper covering portion 302, that is, the protruding length from the upper covering portion 302 is partially increased.

The second upper flange 304 is located on the right side at the downstream end of the upper covering portion 302 and extends forward along the support flare portion 108 and the catalyst accommodating portion 92. The front portion of the second upper flange 304 extends in the vehicle width direction along the exhaust inflow portion 91. The second upper flange 304 has a second upper joint portion 304A at the front end and the rear end. The extending length of each second upper joint portion 304A in a direction away from the upper covering portion 302, that is, the protruding length from the upper covering portion 302 is partially increased.

The lower split part 305 has a lower covering portion 306, which is curved along the outer circumferential surface of the lower semicircular portion of the exhaust conduit 60 to cover the lower semicircular portion. As shown in FIG. 2, the lower split part 305 has a first lower flange 307, which extends along one of the edges in the lower covering portion 306. Also, as shown in FIG. 6, the lower split part 305 has a second lower flange 308, which extends along the other edge in the lower covering portion 306. The first lower flange 307 is located on the left side at the downstream end of the lower covering portion 306 and extends forward along the support flare portion 108 and the catalyst accommodating portion 92. Also, as shown in FIG. 6, the front part of the first lower flange 307 extends in the vehicle width direction (the direction along the depth of the sheet of FIG. 6) along the exhaust inflow portion 91. The first lower flange 307 has a first lower joint portion 307A at the front end and the rear end. The extending length of each first lower joint portion 307A in a direction away from the lower covering portion 306, that is, the protruding length from the lower covering portion 306 is partially increased.

As shown in FIGS. 2 and 6, the second lower flange 308 is located on the right side at the downstream end of the lower covering portion 306 and extends forward along the support flare portion 108 and the catalyst accommodating portion 92. The front portion of the second lower flange 308 extends in the vehicle width direction along the exhaust inflow portion 91. The second lower flange 308 has a second lower joint portion 308A at the front end and the rear end. The extending length of each second lower joint portion 308A in a direction away from the lower covering portion 306, that is, the protruding length from the lower covering portion 306 is partially increased. The first upper flange 303 and the first lower flange 307 have the same shape and are abutted against each other. Also, the second upper flange 304 and the second lower flange 308 have the same shape and are abutted against each other. In this state, the entire circumference in the circumferential direction of the exhaust conduit 60 is covered with the upper covering portion 302 of the upper split part 301 and the lower covering portion 306 of the lower split part 305. A predetermined clearance is provided between the downstream insulator 300 and the exhaust conduit 60. A heat-resistant mat (not shown) is provided in the clearance. The heat-resistant mat is made of a heat-resistant fibrous material such as glass wool and is arranged over the entire circumference in the circumferential direction of the exhaust conduit 60. Since the heat-resistant mat is arranged between the downstream insulator 300 and the exhaust conduit 60, the downstream insulator 300 is kept apart from the exhaust conduit 60. In this state, the downstream insulator 300 is constituted by joining the first upper joint portion 303A of the first upper flange 303 and the first lower joint portion 307A of the first lower flange 307 to each other and joining the second upper joint portion 304A of the second upper flange 304 and the second lower joint portion 308A of the second lower flange 308 to each other. The first upper joint portion 303A and the first lower joint portion 307A are crimped together, and the distal ends are spot-welded together, so that the joint portions 303A and 307A are joined together. The extending lengths of the first upper joint portion 303A and the first lower joint portion 307A are set to lengths required to join the upper split part 301 and the lower split part 305 to constitute the downstream insulator 300. Likewise, the second upper joint portion 304A and the second lower joint portion 308A are crimped together, and the distal ends are welded together, so that the second upper joint portion 304A and the second lower joint portion 308A are joined together. The extending lengths of the second upper joint portion 304A and the second lower joint portion 308A are set to lengths required to join the upper split part 301 and the lower split part 305 to constitute the downstream insulator 300.

As shown in FIGS. 2 and 6, the downstream insulator 300 has a first opening 309 for exposing the first fixing lug 93 provided in the second catalyst support portion 90 of the exhaust conduit 60, a second opening 310 for exposing the second fixing lug 97, and a third opening 313 for exposing the third fixing lug 105. As shown in FIG. 6, the second opening 310 is configured by a third cutout 311, which is provided in the upper covering portion 302, and a fourth cutout 312, which is provided in the lower covering portion 306 and connected to the third cutout 311. The second upper flange 304 is not provided in the part of the upper split part 301 in which the second opening 310 is provided. Also, the second lower flange 308 is not provided in the part of the lower split part 305 in which the second opening 310 is provided. The configuration of the first opening 309 for exposing the first fixing lug 93 is the same as that of the second opening 310 described above. That is, the first opening 309 is configured by a cutout provided in the upper covering portion 302 and a cutout provided in the lower covering portion 306, and the first upper flange 303 is not provided in the part of the upper split part 301 in which the first opening 309 is provided. Also, the first lower flange 307 is not provided in the part of the lower split part 305 in which the first opening 309 is provided. The third opening 313 for exposing the third fixing lug 105 is provided at a position of the lower split part 305 that faces the third fixing lug 105. The third fixing lug 105 extends downward through the third opening 313.

As shown in FIG. 2, the downstream insulator 300 has a rib 314 in a part that covers the support flare portion 108 of the second catalyst support portion 90. The rib 314 is provided on the left side in the vehicle width direction of the upper covering portion 302 is constituted by an upward protrusion. The rib 314 increases the stiffness of the downstream insulator 300.

As shown in FIG. 6, the downstream insulator 300 has a recess 315 in a part that covers the exhaust inflow portion 91 of the second catalyst support portion 90. The recess 315 is provided in the front side of the upper covering portion 302.

As shown in FIG. 2, the turbine-side insulator 320 has a plate shape that is curved to cover the upper side, the rear side, and the lower side of the turbine housing 33. The length in the vehicle width direction of the turbine-side insulator 320 is longer than the length in the vehicle width direction of the turbine housing 33. The turbine-side insulator 320 also covers the bearing housing 32, which is to the left of the turbine housing 33, and a part of the exhaust conduit 60 arranged to the right of the turbine housing 33. The turbine-side insulator 320 extends to a position rearward of the sensor mount 65 of the exhaust conduit 60 and covers the turbine connecting portion 61 of the exhaust conduit 60 and a part of the sensor mount 65.

The turbine-side insulator 320 has a first body portion 321, which covers the turbine accommodating portion 34 and the exhaust discharge portion 35, and a second body portion 322, which is provided to the right of the first body portion 321 and covers the turbine large-diameter portion 36. The turbine-side insulator 320 also has a third body portion 323, which is provided to the right of the second body portion 322 and covers the exhaust flow portion 37, a fourth body portion 324, which is provided to the right of the third body portion 323 and covers the exhaust conduit connecting portion 38 and the turbine connecting portion 61. Further, the turbine-side insulator 320 has a fifth body portion 325, which is provided to the right of the fourth body portion 324 and covers the sensor mount 65 of the exhaust conduit 60.

The first body portion 321 has a shape that is curved along the outer circumferential surfaces of the turbine accommodating portion 34 and the exhaust discharge portion 35. The first body portion 321 has a contact flange portion 321A, which extends behind the bearing housing 32. The left end of the contact flange portion 321A is arranged to the right of the left end of the bearing housing 32 and covers the right end of the bearing housing 32. The front end face of the contact flange portion 321A is in contact with the outer circumferential surface of the bearing housing 32. The contact flange portion 321A is fastened to the bearing housing 32 with a first fixing bolt 350. The contact flange portion 321A is shaped and arranged so as not to cover the support plate 53, which is fixed to the bearing housing 32, and is arranged in the lower portion of the first body portion 321. The first body portion 321 is thus unlikely to interfere with the lubricant supply tube 51 or the coolant supply tube 52, which are fixed to the support plate 53. The first body portion 321 has an upper covering flange portion 321B, which extends to cover the top of the bearing housing 32. The left end of the upper covering flange portion 321B is located to the right of the left end of the bearing housing 32 and to the left of the left end of the contact flange portion 321A.

The turbine-side insulator 320 has a first upper flange portion 326, which extends upward from the first body portion 321. The first upper flange portion 326 is provided continuously from the right end to the left end of the first body portion 321. The position of the upper end of the first upper flange portion 326 ascends from the left end toward the right end of the first upper flange portion 326 and is constant in a section above the turbine accommodating portion 34. Further, the position of the upper end of the first upper flange portion 326 is a step higher in a section above the exhaust discharge portion 35. The first upper flange portion 326 is fastened to the engine body 21 with a second fixing bolt 351 in a section above the boundary between the turbine accommodating portion 34 and the exhaust discharge portion 35.

The turbine-side insulator 320 has a first lower flange portion 331, which extends downward from the first body portion 321. The first lower flange portion 331 is provided continuously from the right end of the first body portion 321 to a middle position of the contact flange portion 321A. The lower end of the first lower flange portion 331 is located above the position of the upper end of the second catalyst support portion 90.

The second body portion 322 has a shape that is curved along the outer circumferential surface of the turbine large-diameter portion 36. The second body portion 322 has a larger diameter than that of the right end of the first body portion 321. The second body portion 322 constitutes a protrusion that protrudes further rearward than the right end of the first body portion 321 and extends in the up-down direction.

The turbine-side insulator 320 has a second upper flange portion 327, which extends upward from the second body portion 322. The second upper flange portion 327 is provided continuously from the right end to the left end of the second body portion 322. The upper end of the second upper flange portion 327 is at the same height as the upper end at the right end of the first upper flange portion 326 and extends horizontally. Also, the turbine-side insulator 320 has a second lower flange portion 332, which extends downward from the second body portion 322. The second lower flange portion 332 is provided continuously from the right end to the left end of the second body portion 322. The position of the lower end of the second lower flange portion 332 ascends from the left end toward the right end of the second lower flange portion 332 and is constant in a center portion of the second body portion 322.

The third body portion 323 has a shape that is curved along the outer circumferential surface of the exhaust flow portion 37. The third body portion 323 has a smaller diameter than that of the right end of the second body portion 322.

The turbine-side insulator 320 has a third upper flange portion 328, which extends upward from the third body portion 323. The third upper flange portion 328 is provided continuously from the right end to the left end of the third body portion 323. The position of the upper end of the third upper flange portion 328 is a step lower than the position of the upper end at the right end of the second upper flange portion 327 and is the same as the position of the upper end of the portion of the first upper flange portion 326 that is located above the turbine accommodating portion 34. Also, the turbine-side insulator 320 has a third lower flange portion 333, which extends downward from the third body portion 323. The third lower flange portion 333 is provided continuously from the right end to the left end of the third body portion 323. From the position corresponding to the right end of the second lower flange portion 332, the lower end of the third lower flange portion 333 descends toward the right end of the third lower flange portion 333.

The fourth body portion 324 has a shape that is curved along the outer circumferential surfaces of the exhaust conduit connecting portion 38 and the turbine connecting portion 61. The fourth body portion 324 has a larger diameter than that of the right end of the third body portion 323. The fourth body portion 324 constitutes a protrusion that protrudes further rearward than the third body portion 323 and extends in the up-down direction. The protruding amount of the fourth body portion 324 with respect to the third body portion 323 is greater than the protruding amount of the second body portion 322 with respect to the third body portion 323. As shown in FIG. 6, the fourth body portion 324 has an upper body portion 324A and a lower body portion 324B, which is provided below the upper body portion 324A. The lower body portion 324B has a shape that bulges downward from the upper body portion 324A. As shown in FIG. 2, the lower body portion 324B of the fourth body portion 324 extends to a position below the third body portion 323.

The turbine-side insulator 320 has a fourth upper flange portion 329, which extends upward from the fourth body portion 324. The fourth upper flange portion 329 is provided continuously from the right end to the left end of the fourth body portion 324. The position of the upper end of the fourth upper flange portion 329 is the same as the position of the upper end of the third upper flange portion 328. Also, the turbine-side insulator 320 has a fourth lower flange portion 334, which extends downward from the fourth body portion 324. The fourth lower flange portion 334 is provided continuously from the right end to the left end of the fourth body portion 324. From the left end of the fourth lower flange portion 334, the lower end of the fourth lower flange portion 334 descends toward the right end of the fourth lower flange portion 334. As shown in FIG. 2, a part of the lower end of the fourth lower flange portion 334 that is to the right of the uppermost position of the second catalyst support portion 90 is located below the upper end of the downstream insulator 300. As shown in FIG. 6, the fourth lower flange portion 334 extends to the interior of the recess 315 of the downstream insulator 300. As shown in FIG. 2, the recess 315 prevents the fourth lower flange portion 334 and the downstream insulator 300 from contacting each other at a position to the right of the first center line L1.

The fifth body portion 325 has a shape that is curved along the outer circumferential surface of the turbine connecting portion 61 of the exhaust conduit 60. The fifth body portion 325 has an insertion hole for attaching the first sensor 171 to the first support lug portion 67. The insertion hole is provided in an upper part of the fifth body portion 325 and at a position corresponding to the first support lug portion 67. The fifth body portion 325 has a smaller diameter than that of the fourth body portion 324. In the vehicle width direction, the position of the right end of the fifth body portion 325 is the same as the position of the upstream end in the upstream insulator 261. In the right side view of the vehicle shown in FIG. 6, the upstream end of the upstream insulator 261 is arranged in the interior of the fifth body portion 325.

The turbine-side insulator 320 has a fifth upper flange portion 330, which extends upward from the fifth body portion 325. The fifth upper flange portion 330 is provided continuously from the right end to the left end of the fifth body portion 325. The position of the upper end at the left end of the fifth upper flange portion 330 is the same as the position of the upper end of the fourth upper flange portion 329. The position of the upper end of the fifth upper flange portion 330 descends toward the right end in a section above the sensor mount main portion 66, and then becomes constant. The position of the upper end at the right end of the fifth upper flange portion 330 is the same as the position of the upper end of of the left end of the first upper flange portion 326. The fifth upper flange portion 330 is fastened to the engine body 21 with a third fixing bolt 352 at a position above the sensor mount main portion 66.

The turbine-side insulator 320 has a fifth lower flange portion 335, which extends downward from the fifth body portion 325. The fifth lower flange portion 335 is provided continuously from the right end to the left end of the fifth body portion 325. From the left end of the fifth lower flange portion 335, the lower end of the fifth lower flange portion 335 descends toward the right end of the fifth lower flange portion 335. The fifth lower flange portion 335 has a lower cutout 335A in the upper part at the right end. The fifth lower flange portion 335 is fastened to the engine body 21 with a fourth fixing bolt 353 at a position below the portion in which the lower cutout 335A is provided. The fifth lower flange portion 335 is arranged in the inner peripheral region R of the exhaust conduit 60. In the up-down direction, a clearance exists between the fifth lower flange portion 335 and the downstream insulator 300. Also, in the vehicle width direction, a clearance exists between the fifth lower flange portion 335 and the bracket 80. The fifth lower flange portion 335 extends to a position below the bracket 80. The lower end of the fifth lower flange portion 335 is located below the upper end of the left end of the upstream insulator 261 in the inner flange portion 285.

In the turbine-side insulator 320, the first body portion 321, the second body portion 322, the third body portion 323, the fourth body portion 324, and the fifth body portion 325 constitute a turbine-side body portion 340, which covers the turbine housing 33. Also, in the turbine-side insulator 320, the first upper flange portion 326, the second upper flange portion 327, the third upper flange portion 328, the fourth upper flange portion 329, and the fifth upper flange portion 330 constitute a turbine-side upper flange portion 341A, which extends upward from the turbine-side body portion 340. The turbine-side upper flange portion 341A is arranged below the upper end face of the engine body 21. Also, in the turbine-side insulator 320, the first lower flange portion 331, the second lower flange portion 332, the third lower flange portion 333, the fourth lower flange portion 334, and the fifth lower flange portion 335 constitute a turbine-side lower flange portion 341B, which extends downward from the turbine-side body portion 340. The turbine-side upper flange portion 341A and the turbine-side lower flange portion 341B constitute a turbine-side flange portion 341, which extends from the turbine-side body portion 340. The fifth lower flange portion 335 in the turbine-side lower flange portion 341B is arranged in the inner peripheral region R of the exhaust conduit 60. That is, the turbine-side flange portion 341 is arranged in the inner peripheral region R of the exhaust conduit 60.

As shown in FIG. 6, the inner flange portion 285 of the exhaust conduit-side insulator 260 is arranged forward of the bracket 80 (right side in FIG. 6). That is, the rear end face of the inner flange portion 285 is arranged forward of the front end face of the bracket 80. In addition, the turbine-side flange portion 341 of the turbine-side insulator 320 is arranged rearward of the bracket 80 (left side in FIG. 6). That is, the front end face of the turbine-side flange portion 341 is arranged rearward of the rear end face of the bracket 80. In this way, in the inner peripheral region R of the exhaust conduit 60, the inner flange portion 285, the bracket 80, and the turbine-side flange portion 341 are arranged on different planes. In other words, in the inner peripheral region R of the exhaust conduit 60, the inner flange portion 285, the bracket 80, and the turbine-side flange portion 341 are arranged at different positions in the front-rear direction of the vehicle.

As shown in FIG. 7, the inner flange portion 285, the bracket 80, and the turbine-side flange portion 341 are arranged so as not to overlap with each other when viewed from the rear of the vehicle.

In FIG. 7, an imaginary line that passes through the center of the second nut 149, which fastens the bracket 80, and extends in the up-down direction is defined as a reference line L4, and an imaginary line that passes through the center of the second nut 149 and extends in the vehicle width direction is defined as a reference line L6. In addition, in FIG. 7, an imaginary line that passes through the center of the welding point between the inner front joint film portion 265A and the inner rear joint portions 269A, which is arranged below the upstream flare portion 86A and extends in the up-down direction is defined as a reference line L5. An imaginary line that passes through the lowest end of the turbine-side flange portion 341 and extends in the vehicle width direction is defined as a reference line L7.

As shown in FIG. 2, the first sensor 171 is provided with a first heat shield case 360, which covers the periphery of the first sensor 171. The first heat shield case 360 has a cylindrical lower portion, which is a portion closer to the exhaust conduit 60, and an upper portion of a conical shape, the diameter of which increases upward from the upper end of the lower portion. The first heat shield case 360 suppresses the transfer of heat to the first sensor 171. The second sensor 172 is provided with a second heat shield case 361, which covers the periphery of the second sensor 172. The second heat shield case 361 has a cylindrical lower portion, which is an end closer to the exhaust conduit 60, and an upper portion of a conical shape, the diameter of which increases upward from the upper end of the lower portion. The second heat shield case 361 suppresses the transfer of heat to the second sensor 172.

The present embodiment has the following advantages.

(1) As indicated by the arrows in FIG. 5, air flow occurs around the internal combustion engine 20 due to, for example, the influence of relative wind. The air thus flowing flows downward between the exhaust conduit 60 and the rear cover 200 of the air guide plate 180 and between the engine body 21 and the exhaust conduit 60.

When flowing around the exhaust conduit member or the heat shield member 250, the air receives heat from these components, which raises the temperature of the air. The air of the increased temperature flows and thus contributes to the temperature rise of the devices arranged around the exhaust conduit member. As shown by the arrow of long dashed short dashed line in FIG. 5, the air flowing from the front to the rear of the inner peripheral region R contributes to the temperature rise of the joint bushing 232 of the steering apparatus 230, which is arranged behind the inner peripheral region R.

In the present embodiment, the heat shield member 250 (specifically, the upstream insulator 261) includes the inner flange portion 285, which is arranged in the inner peripheral region R, and the outer flange portion 290, which is arranged in the outer peripheral region of the curved portion. The inner flange portion 285 and the outer flange portion 290 function to combine and integrate the front split part 262 and the rear split part 266, which constitute the upstream insulator 261. In the upstream insulator 261, the extending length of the inner flange portion 285 is longer than the extending length of the outer flange portion 290. That is, the extending length of the inner flange portion 285 is longer than the length required to join the front split part 262 and the rear split part 266. The long extending length of the inner flange portion 285 hinders the air flowing around the exhaust conduit member from flowing to the inner peripheral region R. It is thus possible to positively cause the air flowing between the engine body 21 and the exhaust conduit 60 to flow downward. Thus, by setting a flow path for the air flowing around the exhaust conduit member in this manner, favorable countermeasures against heat, for example, suppression of heat input to the joint bushing 232 are provided. Therefore, in the configuration in which the exhaust conduit member is connected to the rear face of the engine body 21, it is possible to contribute to optimization of the countermeasure against heat.

Also, since the heat shield member 250, which suppresses heat transfer from the exhaust conduit member to the surrounding devices, is provided with the function of defining the air flow path, the number of components is reduced as compared to a case in which additional members are provided instead of the heat shield member 250.

(2) In the present embodiment, at the inner flange portion 285 of the upstream insulator 261, the opposite ends in the direction of the extending length of the portion arranged below the upstream flare portion 86A are supported by the curved-side body portion 280. Therefore, the vibration of the inner flange portion 285 is suppressed as compared with a configuration in which only one end in the extending direction of the inner flange portion 285 is supported by the curved-side body portion 280.

(3) The bracket 80, which is used to attach the exhaust conduit 60 to the engine body 21, is arranged in the inner peripheral region R of the exhaust conduit 60. Therefore, the bracket 80 hinders the air flowing around the exhaust conduit 60 from flowing into the inner peripheral region R. In this way, the bracket 80 and the inner flange portion 285 define the flow path of the air flowing around the exhaust conduit member. Accordingly, in the configuration in which the exhaust conduit member is connected to the rear face of the engine body 21, the present embodiment adds to the flexibility of the countermeasures against heat.

(4) In the present embodiment, the turbine-side flange portion 341 in the turbine-side insulator 320 is arranged in the inner peripheral region R in the exhaust conduit 60. Therefore, the turbine-side flange portion 341 hinders the air flowing around the exhaust conduit 60 from flowing into the inner peripheral region R. In this manner, in addition to the bracket 80 and the inner flange portion 285, the turbine-side flange portion 341 defines the flow path of the air flowing around the exhaust conduit member. Since the proportion occupied by one member can be reduced by employing a configuration in which three members are arranged in the inner peripheral region R, it is possible to suppress the generation of the vibration of the bracket 80, the inner flange portion 285, and the turbine-side flange portion 341.

(5) In the present embodiment, being arranged on different planes, the inner flange portion 285, the bracket 80, and the turbine-side flange portion 341 are unlikely to contact each other. In a case of employing a configuration for countermeasures against heat by using the inner flange portion 285, the bracket 80, and the turbine-side flange portion 341, the design constraints required for arranging these members in the same plane is relaxed. Therefore, when defining a path through which the air flowing around the exhaust conduit member is caused to flow, it is possible to widen the tolerance such as the dimensions and arrangements of the inner flange portion 285, the bracket 80, and the turbine-side flange portion 341, which adds to the flexibility in design.

(6) In the turbine-side insulator 320, the first lower flange portion 331, the second lower flange portion 332, the third lower flange portion 333, the fourth lower flange portion 334, and the fifth lower flange portion 335 constitute a turbine-side lower flange portion 341B, which extends downward from the turbine-side body portion 340. This makes it difficult for air to flow not only in the inner peripheral region R of the exhaust conduit 60 but also in the region to the left of the inner peripheral region R that is arranged between the turbine housing 33 and the exhaust conduit 60. Therefore, by defining a flow path for the air flowing between the turbine housing 33 and the exhaust conduit 60 by the turbine-side insulator 320, it is possible to take countermeasures against heat for the devices arranged around the exhaust conduit member.

The above-illustrated embodiment may be modified as follows. The following modifications may be combined as necessary.

In the above-described embodiment, the turbine-side insulator 320 defines a flow path for the air flowing between the turbine housing 33 and the exhaust conduit 60. However, the manner of defining such a flow path can be changed as necessary. For example, at least one of the first lower flange portion 331, the second lower flange portion 332, the third lower flange portion 333, the fourth lower flange portion 334, and the fifth lower flange portion 335 may be omitted so that the shape of the turbine-side lower flange portion 341B in the turbine-side insulator 320 is changed. This allows for adjustment of the flow rate of the air flowing between the turbine housing 33 and the exhaust conduit 60. When the fifth lower flange portion 335 is omitted, the fourth lower flange portion 334 is extended rightward, for example. This achieves a configuration in which the turbine-side flange portion 341 is arranged in the inner peripheral region R of the exhaust conduit 60.

In the above-described embodiment, the turbine-side upper flange portion 341A is constituted by the first upper flange portion 326, the second upper flange portion 327, the third upper flange portion 328, the fourth upper flange portion 329, and the fifth upper flange portion 330. However, this configuration may be changed as necessary. For example, at least one of the first upper flange portion 326, the second upper flange portion 327, the third upper flange portion 328, the fourth upper flange portion 329, and the fifth upper flange portion 330 may be omitted. Further, the shape of the turbine-side upper flange portion 341A can be changed as necessary. For example, to facilitate the inflow of air guided to the space above the engine body 21 by the air guide plate 180 to between the turbine housing 33 and the turbine-side insulator 320, a turbine-side upper flange portion 341A may be extended upward beyond the upper end face of the engine body 21.

In the above-described embodiment, the inner flange portion 285, the bracket 80, and the turbine-side flange portion 341 are arranged so as not to overlap with each other when viewed from the rear of the vehicle. The arrangement of the inner flange portion 285, the bracket 80, and the turbine-side flange portion 341 is not limited thereto, and these members may be arranged so as to overlap with each other when viewed from the rear of the vehicle. For example, it is also possible to increase the length in the up-down direction at the left end of the inner flange portion 285 so that the left end of the inner flange portion 285 overlaps with the bracket 80. In addition, the inner flange portion 285 may be extended in the vehicle width direction so that the inner flange portion 285 overlaps with the bracket 80. It is also possible to arrange the inner flange portion 285 so as to overlap only with the turbine-side flange portion 341 without overlapping with the bracket 80.

Further, the bracket 80 may be arranged to overlap with at least one of the inner flange portion 285 and the turbine-side flange portion 341. In this case, it is also possible to cause the bracket 80 to overlap with at least one of the inner flange portion 285 and the turbine-side flange portion 341 by lengthening the bracket 80 in the left-right direction length or the up-down direction. Further, the turbine-side flange portion 341 may be arranged so as to overlap with at least one of the inner flange portion 285 and the bracket 80. In this case, it is also possible to cause the turbine-side flange portion 341 in the above embodiment to overlap with at least one of the inner flange portion 285 and the bracket 80 by changing the shape of the turbine-side flange portion 341 to extend rightward. The turbine-side flange portion 341 may overlap with only the inner flange portion 285 without overlapping with the bracket 80. Furthermore, the inner flange portion 285, the bracket 80, and the turbine-side flange portion 341 may be arranged such that all of these overlap with one another when viewed from the rear of the vehicle.

In this way, when viewed from the rear of the vehicle, the inner flange portion 285, the bracket 80, and the turbine-side flange portion 341 overlap with each other while being separated from each other in the longitudinal direction of the vehicle, so that a flow path is defined in which the air flowing in from the front of the vehicle is changed so as to flow in the vehicle width direction temporarily, and thereafter flows toward the rear of the vehicle. Therefore, air is unlikely to flow through the inner peripheral region R of the exhaust conduit 60, and the amount of air passing through the inner peripheral region R is further limited. Also, it is possible to cause the inner flange portion 285, the bracket 80, and the turbine-side flange portion 341 to overlap with each other when viewed from the rear of the vehicle, while causing these to contact each other in the vehicle front-rear direction.

Other members may be arranged in the inner peripheral region R of the exhaust conduit 60 in addition to the inner flange portion 285, the bracket 80, and the turbine-side flange portion 341. For example, a flange extending upward from the outer circumferential surface of the upper split part 301 of the downstream insulator 300 may be provided, and the flange may be arranged in the inner peripheral region R of the exhaust conduit 60.

The inner flange portion 285, the bracket 80, and the turbine-side flange portion 341 are arranged in different planes, but it is also possible to arrange at least two of these members in the same plane. The phrase “in the same plane” refers to a case in which at least a part of one member is arranged between the front end face and the rear end face of another member in the front-rear direction of the vehicle. For example, the inner flange portion 285 and the bracket 80 can be said to be “in the same plane” when, in the front-rear direction of the vehicle, the rear end face of the inner flange portion 285 is arranged between the front end face and the rear end face of the bracket 80, and the front end face of the inner flange portion 285 is arranged forward of the front end face of the bracket 80. The inner flange portion 285 may be arranged in the same plane as the turbine-side flange portion 341, the bracket 80 may be may be arranged in the same plane as the turbine-side flange portion 341, and the inner flange portion 285, the bracket 80, and the turbine-side flange portion 341 may be all arranged in the same plane.

The portion of the exhaust conduit 60 to which the bracket 80 is connected is not limited to the first catalyst support portion 75. For example, the bracket 80 may be connected to the first curved conduit 86 or the second curved conduit 88 of the curved shape portion 85. Alternatively, the bracket 80 may connected to the exhaust inflow portion 91 of the second catalyst support portion 90.

In the above-described embodiment, the turbine-side flange portion 341 in the turbine-side insulator 320 is arranged in the inner peripheral region R in the exhaust conduit 60. Instead of such a configuration, a configuration may be employed in which the turbine-side insulator 320 is omitted so that the turbine-side flange portion 341 is not arranged in the inner peripheral region R. This modification only requires that the shape of the inner flange portion 285 or the bracket 80, which are arranged in the inner peripheral region R, be appropriately determined from the viewpoint of countermeasures against heat of the devices arranged around the exhaust conduit member. For example, the left end of the bracket 80 may be extended leftward so that the bracket 80 is arranged below the sensor mount 65 of the exhaust conduit 60. It is also possible to extend the inner flange portion 285 leftward so that the inner flange portion 285 is arranged below the sensor mount 65 of the exhaust conduit 60.

In the above-described embodiment, the bracket 80, which is used to attach the exhaust conduit 60 to the engine body 21, is arranged in the inner peripheral region R of the exhaust conduit 60. Instead of such a configuration, it is also possible to employ a configuration in which the bracket 80 is not arranged in the inner peripheral region R. That is, the bracket 80 may be arranged in the outer peripheral region of the exhaust conduit 60. Alternatively, the bracket 80 may be omitted from the exhaust conduit 60. This modification only requires that the shapes of the inner flange portion 285 and the turbine-side flange portion 341, which are arranged in the inner peripheral region R, be appropriately determined from the viewpoint of countermeasures against heat of the devices arranged around the exhaust conduit member. For example, the length in the up-down direction at the left end of the inner flange portion 285 may be increased, so that the upper end of the left end is arranged at a position close to the first catalyst support portion 75. Also, the length in the vehicle width direction of the inner flange portion 285 may be increased, so that the left end of the inner flange portion 285 is arranged at a position close to the right end of the turbine-side flange portion 341. It is also possible to extend the turbine-side flange portion 341 rightward so that the turbine-side flange portion 341 is arranged below the first catalyst support portion 75.

In the above-described embodiment, the inner flange portion 285 of the exhaust conduit-side insulator 260 is provided continuously from the inside of the upstream flare portion 86A of the curved shape portion 85 to the inside of the lateral conduit portion 88C in the flow direction of exhaust gas, so that the right end of the inner peripheral region R of the exhaust conduit 60 is blocked. The shape of the inner flange portion 285 is not limited to this. For example, a configuration may be employed in which the inner flange portion 285 is provided to bridge, in the up-down direction, the inside of the upstream flare portion 86A of the curved shape portion 85 and the inside of the lateral conduit portion 88C, and the inner flange portion 285 is not provided in the inside from the first curved portion 86B to the second curved portion 88B in the flow direction of exhaust gas. In this configuration, an opening through which air can pass is provided in a part of the inner peripheral region R of the exhaust conduit 60 that is to the right of the portion in which the inner flange portion 285 is arranged.

In the above-described embodiment, the inner flange portion 285 is configured such that the proximal end (upper end) and the distal (lower end) in the extending direction (up-down direction) are connected to the curved-side body portion 280 in a portion arranged below the upstream flare portion 86A. The configuration of the inner flange portion 285 is not limited to this. For example, the inner flange portion 285 may have a configuration in which the distal end in the extending direction is not connected to the curved-side body portion 280 in a portion arranged below the upstream flare portion 86A. Also, the inner flange portion 285 may have a cutout.

In the above-described embodiment, the inner front flange 265 of the front split part 262 includes the inner front joint film portion 265A, and the inner rear flange 269 of the rear split part 266 includes the inner rear joint portions 269A. However, the inner front flange 265 may have the inner rear joint portions 269A, and the inner rear flange 269 may have the inner front joint film portion 265A.

In the above-described embodiment, the shape of the inner front joint film portion 265A of the inner front flange 265 and the shape of the inner rear joint portions 269A of the inner rear flange 269 are different from each other. Instead of such a configuration, the inner rear joint portions 269A and the inner front joint film portions 265A may have the same shape and be stacked and joined together to constitute the inner flange portion 285. Since the thickness of the inner flange portion 285 is increased as compared with the above embodiment, this modification is suitable for increasing the stiffness of the inner flange portion 285. In this configuration, in which the inner rear joint portions 269A and the inner front joint film portion 265A are stacked to increase the thickness of the inner flange portion 285, the thickness of only the inner flange portion 285 can be increased without changing the thickness of the curved-side body portion 280. Therefore, it is possible to increase the stiffness of the inner flange portion 285 while suppressing the increase in weight, as compared with a configuration in which the thickness of the entire upstream insulator 261 is increased to increase the thickness of the inner flange portion 285. In this way, from the viewpoint of increasing the stiffness of the inner flange portion 285, it is also possible to appropriately change the thickness of the inner front joint film portion 265A and the thickness of the inner rear joint portions 269A.

A protrusion may be provided on the front side surface of the inner flange portion 285. In this configuration, the protrusion increases the stiffness of the inner flange portion 285 and also adjusts the direction of air flow.

In the above-described embodiment, the exhaust conduit 60 is curved into a U-shape such that the flow of the exhaust gas flowing rightward in the vehicle width direction is directed downward and then leftward in the vehicle width direction. The shape of the exhaust conduit 60 is not limited to this. For example, the exhaust conduit 60 may be curved into a U-shape such that the flow of the exhaust gas flowing leftward in the vehicle width direction is directed downward and then rightward in the vehicle width direction. Further, the exhaust conduit 60 may have a curved shape other than a U-shape. In this case, for example, the exhaust conduit 60 may be curved into an L-shape such that the flow of exhaust gas flowing rightward in the vehicle width direction is directed rearward. In this case, if the extending length of the inner flange portion arranged in the inner peripheral region of the curved portion of the exhaust conduit having such an L shape is set to be longer than the extending length of the outer flange portion arranged in the outer peripheral region of the curved portion of the exhaust conduit, the air flowing about the exhaust conduit member is unlikely to flow to the inner peripheral region. The flow path of the air can be defined accordingly. However, if the space between the engine body 21 and the dashboard 210 is narrow in the engine compartment 10, the exhaust conduit is desirably curved into a U-shape in order to ensure a sufficient passage length of the exhaust passage.

Although the above-described embodiment provides a configuration in which the heat-resistant mat is sandwiched between the exhaust conduits 60 and the set of the upstream and the downstream insulators 261, 300, the heat-resistant mat is not necessarily required. That is, it is possible to omit the heat-resistant mat. If the heat-resistant mat is omitted, the upstream insulator 261 can be supported by exhaust conduit 60 in the following manner, for example. That is, a support portion for supporting the upstream insulator 261 on the exhaust conduit 60 is provided on the inner circumferential surface of the upstream insulator 261. By connecting this support portion to the outer circumferential surface of the exhaust conduit 60, the upstream insulator 261 is attached to the exhaust conduit 60 in a state separated from the exhaust conduit 60. This configuration is applicable to the downstream insulator 300.

In the upstream insulator 261 of the above-described embodiment, the outer front joint portions 264A and the outer rear joint portions 268A are joined together by crimping and welding, and the inner front joint film portions 265A and the inner rear joint portions 269A are joined together by crimping and welding. These joining methods can be changed as necessary. For example, these members may be joined together by welding only or by crimping only. It is also possible to construct the upstream insulator 261 by joining the above members using a joining method different from welding or crimping, such as adhesion. This configuration is applicable to the downstream insulator 300.

The upstream insulator 261 in the above-described embodiment is constituted by the two members, which are the front split part 262 and the rear split part 266. However, the upstream insulator 261 may be constituted by three or more members. This configuration also only requires that two or more flange portions, which include an inner flange portion and an outer flange portion, be used to join the multiple members, and that the extending length of the inner flange portion arranged in the inner peripheral region of the exhaust conduit be made longer than the extending length of the outer flange portion arranged in the outer peripheral region of the exhaust conduit.

The downstream insulator 300 in the above-described embodiment is constituted by the two members, which are the upper split part 301 and the lower split part 305. However, the downstream insulator 300 may be constituted by three or more members. This configuration also only requires that two or more flange portions, which include an inner flange portion and an outer flange portion, be used to join the multiple members, and that the extending length of the inner flange portion arranged in the inner peripheral region of the exhaust conduit be made longer than the extending length of the outer flange portion arranged in the outer peripheral region of the exhaust conduit.

In the exhaust conduit-side insulator 260 of the above-described embodiment, the upstream insulator 261 and the downstream insulator 300 are separately constructed. However, these can be constituted as a single member.

The shape of each of the first fixing lug 93, the second fixing lug 97, and the third fixing lug 105 can be changed as necessary. For example, the second front wall portion 101 of the second fixing lug 97 may be omitted so that the second fixing lug 97 has an opening facing forward.

The position and shape of the rib 314, which is provided in the downstream insulator 300 in the above-described embodiment, may be changed as necessary. For example, two or more ribs may be provided in the downstream insulator 300. In order to increase the stiffness, the upstream insulator 261 or the turbine-side insulator 320 may have a rib as necessary.

In the above-described embodiment, the downstream insulator 300 has the recess the recess 315, so that the turbine-side flange portion 341 and the downstream insulator 300 are prevented from contacting each other while arranging the turbine-side flange portion 341 of the turbine-side insulator 320 at a position close to the downstream insulator 300. The recess 315 does not necessarily have to be provided. It is also possible to determine the size and shape of the turbine-side flange portion 341 such that the turbine-side flange portion 341 contacts the downstream insulator 300.

The number of catalysts accommodated in the exhaust conduit 60 and the number of attached sensors can be changed as necessary. Also, the accommodation position of the catalyst and the attachment position of the sensor can be changed. For example, a catalyst may be accommodated in the curved shape portion 85. For early warm-up of the catalyst, it is desirable to place the catalyst on the upstream side in the flow of exhaust gas.

The shape of the turbine housing 33 is not limited to that of the above-described embodiment but may be changed as necessary.

In the above-described embodiment, the forced-induction device 30 is provided in the internal combustion engine 20. However, the forced-induction device 30 is not necessarily required. That is, the upstream end of the exhaust conduit 60 may be connected to the engine main body without the turbine housing 33 in between.

1. An exhaust system apparatus for an internal combustion engine mounted on a vehicle, the internal combustion engine including an engine body having a rear face located on a rear side in a front-rear direction of the vehicle, the exhaust system apparatus comprising:
an exhaust conduit member, which is configured to be connected to the rear face of the engine body and allow exhaust gas to flow inside; and
a heat shield member, which covers the exhaust conduit member, wherein
the exhaust conduit member includes a curved portion,
a region on an inner peripheral side of the curved portion is an inner peripheral region,
a region on an outer peripheral side of the curved portion is an outer peripheral region,
the heat shield member has a curved-side body portion, which covers the curved portion, an inner flange portion, which extends from the curved-side body portion and is arranged in the inner peripheral region, and an outer flange portion, which extends from the curved-side body portion and is arranged in the outer peripheral region, and
an extending length of the inner flange portion in a direction away from the curved-side body portion is longer than an extending length of the outer flange portion in a direction away from the curved-side body portion.

2. The exhaust system apparatus according to claim 1, wherein
the curved portion of the exhaust conduit member is curved into a U-shape, and
both ends in a direction of the extending length of the inner flange portion are connected to the curved-side body portion.

3. The exhaust system apparatus according to claim 1, wherein
the exhaust conduit member includes a turbine housing of a forced-induction device, which is configured to be connected to the rear face of the engine body, and an exhaust conduit, which is connected to a downstream end in an exhaust flow of the turbine housing,
the exhaust conduit has an exhaust main conduit, which includes the curved portion, and a bracket, which extends from an outer circumferential surface of the exhaust main conduit and is configured to attach the exhaust conduit to the engine body, and
the bracket is arranged in the inner peripheral region.

4. The exhaust system apparatus according to claim 3, wherein
the heat shield member includes an exhaust conduit-side insulator, which covers the exhaust conduit, and a turbine-side insulator, which covers the turbine housing,
the exhaust conduit-side insulator includes the curved-side body portion, the inner flange portion, and the outer flange portion,
the turbine-side insulator includes a turbine-side body portion, which covers the turbine housing, and a turbine-side flange portion, which extends from the turbine-side body portion, and
the turbine-side flange portion is arranged in the inner peripheral region.

5. The exhaust system apparatus according to claim 4, wherein the inner flange portion, the bracket, and the turbine-side flange portion are arranged in different planes in the inner peripheral region.

6. The exhaust system apparatus according to claim 4, wherein the inner flange portion, the bracket, and the turbine-side flange portion are arranged at different positions in the front-rear direction of the vehicle.

7. The exhaust system apparatus according to claim 4, wherein the inner flange portion, the bracket, and the turbine-side flange portion are arranged so as not to overlap with each other when viewed from a rear of the vehicle.

8. The exhaust system apparatus according to claim 1, wherein
the curved portion of the exhaust conduit member is curved into a U-shape so as to have sections that face each other, and
the inner flange portion connects the sections of the curved portion that face each other.

9. The exhaust system apparatus according to claim 1, wherein
the exhaust conduit member has a bracket, which is configured to attach the exhaust conduit member to the engine body, and
the bracket is arranged in the inner peripheral region.

10. The exhaust system apparatus according to claim 9, wherein the inner flange portion and the bracket are arranged in different planes in the inner peripheral region.

11. The exhaust system apparatus according to claim 9, wherein the inner flange portion and the bracket are arranged at different positions in the front-rear direction of the vehicle.

12. The exhaust system apparatus according to claim 9, wherein the inner flange portion and the bracket are arranged so as not to overlap with each other when viewed from a rear of the vehicle.

13. The exhaust system apparatus according to claim 1, wherein
the exhaust conduit member includes a turbine housing of a forced-induction device, which is configured to be connected to the rear face of the engine body, and an exhaust conduit, which is connected to a downstream end in an exhaust flow of the turbine housing,
the heat shield member includes an exhaust conduit-side insulator, which covers the exhaust conduit, and a turbine-side insulator, which covers the turbine housing,
the turbine-side insulator includes a turbine-side body portion, which covers the turbine housing, and a turbine-side flange portion, which extends from the turbine-side body portion, and
the turbine-side flange portion is arranged in the inner peripheral region.

14. The exhaust system apparatus according to claim 13, wherein the inner flange portion and the turbine-side flange portion are arranged in different planes in the inner peripheral region.

15. The exhaust system apparatus according to claim 13, wherein the inner flange portion and the turbine-side flange portion are arranged at different positions in the front-rear direction of the vehicle.

16. The exhaust system apparatus according to claim 13, wherein the inner flange portion and the turbine-side flange portion are arranged so as not to overlap with each other when viewed from a rear of the vehicle.
